(19) United States
(12) Patent Application Publication
(10) Pub. No.: US 2005/0273600 A1
(43) Pub. Date: Dec. 8, 2005

(54) Method and system for file data access within a secure environment

(76) Inventor: El-azar Seeman, Rehovot (IL)

Correspondence Address: El-azar Seeman, Apt. 4, 40 Gorodesky St., Rehovot, 76227, IL

(21) Appl. No.: 11/135,554

(22) Filed: May 24, 2005

Related U.S. Application Data
(63) Continuation of application No. 10/356,025, filed on Feb. 3, 2003.

(51) Int. Cl. H04L 9/00

(52) U.S. Cl. 713/160

(57) ABSTRACT

A computer data security system, including a file parser for determining if a computer file contains protected data, a file decrypter for decrypting encoded files, a file encrypter for re-encoding decrypted files that have been modified, a rights processor for determining data usage rights for a process that has been launched, the data usage rights restricting the process by limiting permissible data access commands that can be issued by the process, and a process monitor for monitoring processes within a computer, including a command interceptor for intercepting a data access command issued by the process, and a command blocker for blocking the intercepted command if the intercepted command accesses protected data, and if the data usage rights indicate that the command is not permissible. A method is also described and claimed.

### PRIORITY REFERENCE TO RELATED APPLICATIONS

This application is a continuation of U.S. application Ser. No. 10/356,025, entitled “METHOD AND SYSTEM FOR PROTECTING DOCUMENTS WHILE MAINTAINING THEIR EDITABILITY”, filed on Feb. 3, 2003 by inventor El-azar Seeman.

### FIELD OF THE INVENTION

The present invention relates to electronic file and document security systems.

### BACKGROUND OF THE INVENTION

One of the great innovations of the Information Age has been the ability to store information in digital format—which affords, among other benefits, the ability to effortlessly reproduce and transmit the information. This property of digital information has been a primary mover in enabling a digital workplace, as well as Internet-based commerce; however, the very ease with which digital information can be reproduced and transmitted has proven to be a dual-edged sword: with a few mere mouse clicks, a user can inadvertently or malevolently copy that information and send it to unauthorized destinations within seconds.

This problem has led to the development of a class of technologies, commonly referred to as Digital Rights Management (DRM), whose purpose is to restore a measure of control to the original information owner. Typically, DRM technologies work to prevent unauthorized dissemination of digital information by controlling its usage; in effect, a ‘net’ is cast around the information, such that the user's ability to reproduce/transmit that information in usable form is constrained—and it is this constraint which serves as the core protection mechanism. With the core mechanism in place, other usage constraints can be applied as well, e.g., allowing n playbacks of a downloaded music file.

DRM technologies have been applied to Internet commerce, e.g., embedding of usage constraints in digital media that are downloaded by users, as well as to corporate information, for limiting usage rights for sensitive corporate documents. One of the leading DRM technologies today, developed by InterTrust, enables a content owner to encrypt target information and usage-related meta-data in a “DigiBox”; the recipient can decrypt and access the information only via a proprietary viewer/player—which subsequently controls usage rights.

Waltham, Mass.-based Authentica specializes in corporate DRM. Authentica's technology encrypts selected documents, but, unlike InterTrust, stores usage rights for the given documents separately on a ‘Policy Server’; the document recipient, using an Authentica plug-in, decrypts the document, renders the content in a proprietary window, or in Adobe Acrobat format, to prevent unauthorized copying, and subsequently queries the Policy Server for usage rights.

Austin-based Infraworks' technology is comprised of two components: a ‘Packager’ and a ‘Receiver’. The Packager enables a user to select specific documents, convert them to a protected format, and bundle together access/usage rights, similarly to InterTrust. The Receiver allows the protected document/s to be viewed in native format, unlike InterTrust and Authentica, but enforces usage settings—including a default prevention of copying.

Boca Raton-based Adhaero, formerly known as WinVista, specializes in the protection of Microsoft Office documents and email messages. Adhaero enables documents to be viewed in native format, with limited editability; however, Windows copying utilities such as the clipboard and ‘Print Screen’ button are disabled, even for use by unprotected documents, while a protected document is being viewed.

Grapevine, Tex.-based Alchemedia specializes in protection of content on corporate intranets. Alchemedia's technology matches user HTTP requests against a set of predefined rules; if a match is found, the requested document is served up in encrypted form—while the Alchemedia client converts only the graphic rendering to screen into readable form, such that the document is literally read-only.

The efficacy of these, and other typical DRM paradigms is greatest when the target information is:
1. Predetermined—i.e. known in advance and distributed at the owner's initiative, such that the owner can appropriately flag it for protection, e.g., by embedding usage constraints in the information, and/or creating remotely-stored usage rules that are queried at run-time when the target information is accessed; and
2. Intended for limited usage—i.e. the information is meant to be used in a limited capacity, viewed or played, such that usage constraints would in any case not detract from the information's overall utility.

These conditions are well met in an Internet commerce environment, in which the content owner provides designated items of information, such as music files and images, for customers to download and use in a limited capacity, such as playback and viewing. Similarly, the above conditions can be met within the context of business communications—where the owner would designate sensitive information, and seek to impart it to recipients in read-only or limited-functionality format. Indeed, it is in these two contexts that existing DRM technologies have been applied most successfully.

Another perceived application of conventional DRM technologies has been the protection of corporate information from abuse by authorized insiders—i.e. the employees. However, in the corporate workplace, where large numbers of employees continually generate and share large quantities of information, neither of the above two conditions—predetermination of the information and limitations on its usage—can be adequately met. Predetermination is problematic, inasmuch as the information is generally created and distributed between employees in peer-to-peer fashion, via email or over a LAN, such that it cannot be centrally monitored and flagged by the ‘owners’ of the information, e.g., upper management.

Likewise, limitations on usage of information cannot be assumed in the corporate workplace; inasmuch as the work of employees is a collaborative process, the information generated by employees will often need to be shared in a ‘malleable’, i.e., fully editable and reproducible format if that collaboration is to be effective. For example, a software engineer will commonly copy code from existing files in producing a new source code file; a product manager receiving a technical specification from the engineering group might then convert it into a PowerPoint presentation for senior management; and a technical/marketing writer, in developing a product white paper, may paste in text from previous documents or specifications, as well as diagrams and screen shots.

In all the above cases, the information in question could be highly sensitive, yet there may be no centralized mechanism to monitor such information—especially while it is still ‘work in progress’ that is distributed in peer-to-peer fashion; and that information must be in malleable form such that it can readily be reworked, rather than fossilized in a static or semi-static format, for collaboration to be truly effective. This in fact represents the typical state of affairs in the corporate workplace—yet it is precisely there that existing DRM technologies fail.

Using existing DRM technologies, comprehensive protection for corporate data would require that all information be monitored, so that the information targeted for protection can be differentiated from other information, inasmuch as the usage rights associated with the former will be limited as compared to the latter; yet even if a monitoring mechanism were to exist, it could not be utilized—because the existing technologies cannot protect dynamic, evolving information such as design documents, source code, data tables, and draft specifications, without impeding the ability of employees to work with that information. In fact, even where protection is provided for read-only information, distributed via e-mail attachments and, Intranet—that protection is porous, in that there is no defense against persons who had access to the information before it was converted to read-only format; i.e., while it was under development). Thus, it would appear that existing DRM technologies are fundamentally unable to provide a comprehensive solution to the problem of corporate information protection. Indeed, this may explain to a large extent why these technologies have to date not been widely adopted in the corporate market.

It is no coincidence that none of the conventional DRM technologies are capable of providing comprehensive protection for corporate information. The issue is not simply one of technological nuance; e.g., Alchemedia's technology prevents copying by 3^{rd}-party screen capture applications, unlike other technologies. Rather, it is based on the conceptual approach that all of the existing technologies share—namely, the equating of protection with usage constraints. This equation is in fact a heuristic, inasmuch as the primary purpose of protecting digital information is actually to ensure that the information is not transmitted to unauthorized users in usable form. The ‘protection=constraints’ heuristic is perhaps valid in the realm of Internet commerce, where the user is untrusted and usage is limited in any event, but as demonstrated above, it is not tenable in the corporate workplace—where applying constraints on employees' usage rights could seriously impede work processes, other than under select conditions—e.g., distributing a ‘critical procedures’ document in read-only format, to ensure that employees are working with the definitive version. The existing DRM technologies—most of which are derived from, or continue to be based on Internet commerce models—use the ‘protection=constraints’ heuristic as their protection criterion, and are thus intrinsically unsuited to protect anything but a small percentage of the information circulating in the typical corporate environment.

### SUMMARY OF THE INVENTION

The present invention provides a method and system for protecting digital documents from unauthorized dissemination, while enabling a practically unlimited range of usage options. The invention is distinguished from prior art in a number of respects. The first distinction is that the invention decouples usage constraints from the protection mechanism; rather than applying usage constraints, the invention uses as its protection benchmark the principle that protected information must not reach unauthorized users in usable form. Thus, activities on the part of the user that do not violate this principle, such as editing, copying, and pasting of information, can be permitted. The protection mechanism tracks the flow of protected information, ensuring that the protection attribute ‘sticks to’ the information—such that it is subsequently stored and transmitted in protected format. This capability, which is generic to any Windows file format, enables the protection of data that previously could never be effectively secured via existing DRM technologies, e.g. source code.

A second distinction, arising out of the fact that protection does not carry any intrinsic usage penalty, is that the information owner does not need to actively pre-select documents requiring protection; rather, embodiments of the invention can automatically protect any and all documents they encounter, without distinction—enabling protection to be applied to the entire body of information circulating within (and transmitted out of) an enterprise.

The present invention uses client-side software to decrypt protected information, enforce the usage rights associated with the information, monitor the flow of protected information across the end-user's machine (where permitted), and subsequently encrypt protected information when it is saved. It also uses a server computer to provide de/encryption keys, usage rights, and data lists for clients. It also uses an administration tool for managing the above server-based information.

There is thus provided in accordance with a preferred embodiment of the present invention a computer data security system, including a file parser for determining if a computer file contains protected data, a file decrypter for decrypting encoded files, a file encrypter for re-encoding decrypted files that have been modified, a rights processor for determining data usage rights for a process that has been launched, the data usage rights restricting the process by limiting permissible data access commands that can be issued by the process, and a process monitor for monitoring processes within a computer, including a command interceptor for intercepting a data access command issued by the process, and a command blocker for blocking the intercepted command if the intercepted command accesses protected data, and if the data usage rights indicate that the command is not permissible.

There is further provided in accordance with a preferred embodiment of the present invention a method for computer data security, including determining if a computer file contains protected data, decrypting encoded files, re-encoding decrypted files that have been modified, determining data usage rights for a process upon launch of the process, the data usage rights restricting the process by limiting permissible data access commands that can be issued by the process, intercepting a data access command issued by the process, and blocking the intercepted command if the intercepted command accesses protected data, and if the data usage rights indicate that the command is not permissible.

There is yet further provided in accordance with a preferred embodiment of the present invention A computer data security system, including a file parser for determining if a computer file contains protected data, a file decrypter for decrypting encoded files into memory, a file encrypter for encrypting files containing protected data, and a security processor for indicating to a process that data it receives from memory is protected data.

### BRIEF DESCRIPTION OF THE DRAWINGS

The present invention will be more fully understood and appreciated from the following detailed description, taken in conjunction with the drawings in which:

FIG. 1 is a simplified illustration of a system for protecting documents from unauthorized access while enabling a full range of usage options, for use within a distributed client-server environment, in accordance with a preferred embodiment of the present invention;

FIG. 2 is a simplified illustration of a system, residing on a server computer, for designating usage rights as well as providing decryption/encryption keys and data lists, in accordance with a preferred embodiment of the present invention;

FIG. 3 is a simplified illustration of a system, residing on a client computer, for accessing protected information and enforcing the usage rights that are associated with it, in accordance with a preferred embodiment of the present invention;

FIG. 4 is a simplified flowchart of a method for updating Client settings, in accordance with a preferred embodiment of the present invention;

FIG. 5 is a simplified flowchart of a method for determining the usage rights that are designated for a given Client, in accordance with a preferred embodiment of the present invention;

FIG. 6 is a simplified flowchart of a method for reading protected files, in accordance with a preferred embodiment of the present invention;

FIG. 7 is a simplified flowchart of a method for creating a whiteboard record for a Client computer process opening a protected file, in accordance with a preferred embodiment of the present invention;

FIG. 8 is a simplified flowchart of a method for calculating the usage rights that are designated for a Client computer process opening a protected file, in accordance with a preferred embodiment of the present invention;

FIG. 9 is a simplified flowchart of a method for monitoring for the launch of conditionally-protected processes, in accordance with a preferred embodiment of the present invention;

FIG. 10 is a simplified flowchart of a method for monitoring protected data that is transferred to the Windows clipboard via ‘Cut’ or ‘Copy’ operations, or via an <ALT>‘Print Screen’ keystroke combination, in accordance with a preferred embodiment of the present invention;

FIG. 11 is a simplified flowchart of a method for monitoring protected data that is transferred to the Windows clipboard via the ‘Print Screen’ key, in accordance with a preferred embodiment of the present invention;

FIG. 12 is a simplified flowchart of a method for transferring protected data to another process on the Client computer while preserving the data's attributes, in accordance with a preferred embodiment of the present invention;

FIG. 13 is a simplified flowchart of a method for printing protected information, in accordance with a preferred embodiment of the present invention;

FIG. 14 is a simplified flowchart of a method for saving protected information to disk, in accordance with a preferred embodiment of the present invention;

FIG. 15 is a simplified flowchart of a method for monitoring for the shutdown of protected processes or windows, in accordance with a preferred embodiment of the present invention;

FIG. 16 is an illustration of a user interface tab for managing the Server's authentication key and de/encryption key lists, in accordance with a preferred embodiment of the present invention;

FIG. 17 is an illustration of a user interface tab for managing the Server's usage rule list, in accordance with a preferred embodiment of the present invention;

FIG. 18 is an illustration of a user interface tab for determining the mechanism that is used to generate user profiles, in accordance with a preferred embodiment of the present invention;

FIG. 19 is an illustration of a user interface tab for managing lists of applications that have been designated for special handling, in accordance with a preferred embodiment of the present invention; and

FIG. 20 is an illustration of a user interface tab for issuing specific directives to individual clients, in accordance with a preferred embodiment of the present invention.

### DETAILED DESCRIPTION OF A PREFERRED EMBODIMENT

The present invention provides a method and system for protecting digital information from unauthorized dissemination, while enabling a practically unlimited range of usage options. Unlike prior art methods, which rely on constraining the usage rights of the end-user in order to prevent the information from being reproduced and disseminated in an unauthorized manner, the invention uses a protection mechanism which is independent of usage constraints. Thus, the information owner can designate any degree of usage constraints—including none at all—without adversely affecting the protection itself.

The invention is comprised of three components: client-side software, a server computer, and an administration tool. The client contains a process-monitoring mechanism that intercepts selected function calls of the Windows operating system relating to the access and the usage of information, and identifies the Windows process from which any given call was made. In the invention, protected information is encrypted to disk; when the monitoring mechanism detects that the client computer is accessing encrypted information (e.g. where the user is opening a file from the local file system or over a network), the process from which the accessing calls were made is flagged as ‘protected’. Function calls that transfer information from one process to another (via the Windows clipboard, or programmatic forwarding) are intercepted by the process-monitoring mechanism, which locates the source of the call: if the source process is protected, the destination process is flagged as ‘protected’ as well, and it receives the protection attribute/s of the source. Function calls saving information to disk are also intercepted by the process-monitoring mechanism; if the calling process is protected, the information in question is encrypted before being saved to disk (locally, or to a remote computer).

Some applications, such as chat programs, are designed to transfer data in memory to other computers, rather than saving it to disk. In order to prevent the loss of protected information through such channels, the client maintains a list of ‘blacklisted’ applications into which transfer of protected information is blocked.

Some applications, most notably screen capture programs, possess the ability to reproduce the information within a given window by copying the pixels on screen. In order to ensure that information can continue to be protected even when reproduced in this manner, the client maintains a list of conditionally-protected applications. When the process-monitoring mechanism detects the launching of a process by an application appearing in the list, it flags the process as ‘conditionally-protected’; that is, if any normally-protected processes are running, the conditionally-protected process will be flagged as protected as well.

While protection can be effected without constraining the end-user's ability to edit, copy, or otherwise work with the information, usage constraints may be desirable in of themselves under certain circumstances. For example, source code files could be designated as ‘read-only’ for non-programmers, so that such users—who in any case are not meant to work with the code—could not inadvertently (or otherwise) tamper with it. In order to work with a range of usage-constraint scenarios, the client possesses both default and rule-based usage rights that it applies when accessing protected information. Rule-based rights are resolved at run-time by being matched against properties that may appear in the meta-data of protected documents; default rights are utilized if rights have not otherwise been resolved. Usage rights may thus vary from process to process. Depending on the rights that are associated with a given process, the process-monitoring mechanism may block function calls involving the transfer, printing, or saving of protected information.

The server is the component that provides clients with de/encryption keys, usage rights, and data lists. The server is comprised of the following components: a list of asymmetric keys that are used to encrypt and authenticate client-server transactions, a list of symmetric keys that are requested by clients in order to decrypt and subsequently encrypt protected information, a generator for the above keys, a ‘user profile’ generator that provides each client with properties from which usage rights will be determined, a list of usage rules, a rule-matching engine that compares a client's properties against the usage rule list in order to determine the client's default and rule-based usage rights, a ‘blacklisted applications’ list, a ‘conditionally-protected applications’ list, and a request handler that manages I/O with clients and the administration GUI, using HTTP.

The server is prompted for a de/encryption key when a given client attempts to access protected information for which the required key is not already locally stored. It is prompted for a user profile if the client does not possess one—e.g. subsequent to installation. Otherwise, the server is prompted regularly by clients in order to determine whether client settings require updating. Depending on the value of a timestamp that a given client sends in its prompt, the server may respond by prompting it to refresh its usage rights and/or its ‘blacklisted applications’ list and/or ‘conditionally-protected applications’ list. The client subsequently does so, receiving the required information from the server.

The server is managed via a web-based administration tool. The tool is comprised of four tabs: the ‘Keys’ tab enables the administrator to add or delete entries in the server's authentication key and de/encryption key lists, as well as specify a de/encryption key that clients will use as a default; the ‘Usage Rules’ tab enables the administrator to add new rules to the server's usage rule list, or modify or delete existing rules; the ‘User Profiles’ tab enables the administrator to select the mechanism that will be used to generate user profiles for clients; and the ‘Predesignated Applications’ tab enables the administrator to refresh the ‘blacklisted applications’ and ‘conditionally-protected applications’ lists.

Because the present invention protects files of any valid Windows format, it can be applied to a wide range of information—e.g. Office documents, source code, database files, etc. At the same time, different information types may differ significantly with respect to their protection criteria (e.g. all source code files on an end-user's machine may require protection, whereas certain Word documents—such as those containing personal information—would not); they may also differ in the manner in which they are utilized and shared (e.g. source code files are generally accessed from a central repository, whereas Office documents are commonly transmitted over a LAN, intranet, or via e-mail). Thus, the process of identifying and flagging sensitive information—which serves to initiate protection—may differ for different information types.

In order to provide a protection model that is suitable to any information type, while at the same time accommodating the potential requirements posed by different information types regarding initiation of protection, the present invention is designed as a generic, extendable architecture. The core architecture protects information while enabling a full range of usage options, including the ability to edit and/or reproduce the information—regardless of information type; embodiments of the core architecture, on the other hand, will serve a bridging function, integrating with various information environments, and enabling protection to be initiated from within those environments. For example, an embodiment protecting source code could consist of a simple list, residing on the Client, of compilers and/or version control systems that are automatically flagged as ‘protected’—such that the Client will encrypt any files generated via those applications; whereas an embodiment protecting documents sent via email may be manifested as a filter, residing on the corporate mail server, that encrypts attachments that are sent between employees.

1. Overview

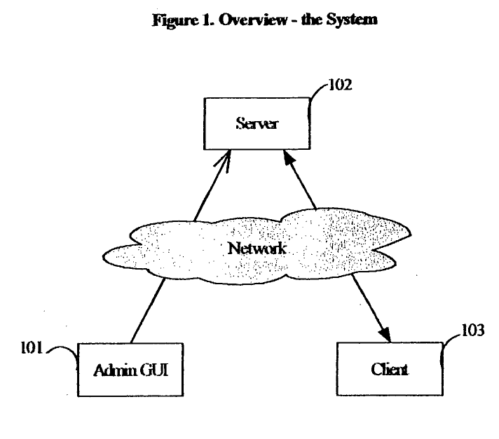

Reference is now made to FIG. 1, which is a simplified illustration of a system for protecting documents from unauthorized access while enabling a full range of usage options, for use within a distributed client-server environment, in accordance with a preferred embodiment of the present invention.

101. Admin GUI

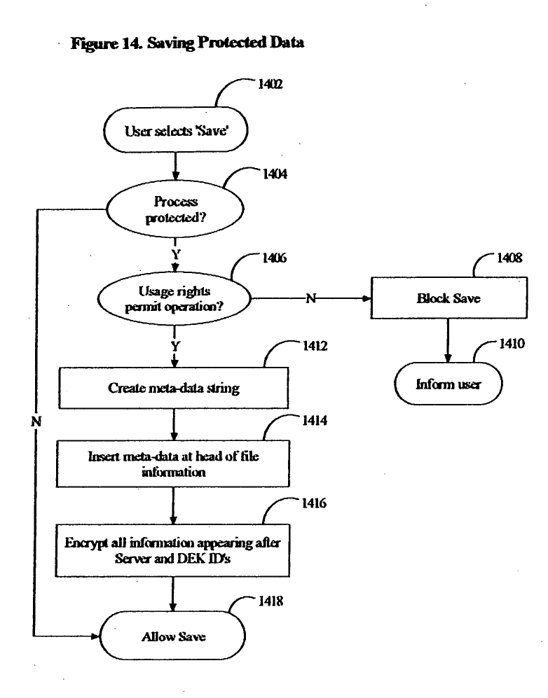

Admin GUI 101 is a Web-based interface, or a stand-alone application, through which an administrator can remotely configure the settings stored on server computer 102. The GUI is comprised of various ‘tabs’ (illustrated in FIGS. 14-17), each representing a different functional aspect to be configured. All admin-server transactions are encrypted via a public-private key pair in order to enhance security and ensure the veracity of the admin requests. Alternatively/additionally, admin privileges are password-based.

102. Server

Server computer 102 creates and stores the keys that are subsequently requested by clients in order to decrypt/encrypt protected information. In addition, server computer 102 is the central repository for the information that governs the behavior of Clients; it houses data lists that are requested by the Client, as well as information usage rules which it uses to designate usage rights to Clients.

The Server interacts with clients via a network protocol such as HTTP. All client-server transactions are encrypted via a public-private key pair, in order to enhance security and ensure the veracity of the client requests. The Server can service any number of clients, residing in any number of locations.

103. Client

Client computer 103 houses the mechanism that enables the user to view and, if permitted, to work with protected information. In the present invention, protected information is encrypted on disk; where the user seeks to access such information—e.g. by opening a protected file—client computer 103 decrypts and, after usage, encrypts it, using a key obtained from server computer 102.

Client computer 103 also serves to enforce usage rights associated with protected information. Client computer 103 determines the end-user's rights by querying the usage rule base on server computer 102. In addition, local usage constraints may be implanted within the information itself, which client computer 103 detects upon decryption and subsequently resolves with the user-based rights.

Usage rights can, if desired, be broad enough to permit end-users to work with—and hence reproduce—protected information. Client computer 103 can safely allow this, owing to the presence of a monitoring mechanism that tracks the flow of protected information on the user's machine—and flags the information as ‘protected’ in its new location as well, such that it will be encrypted when saved to disk.

2. Server Architecture

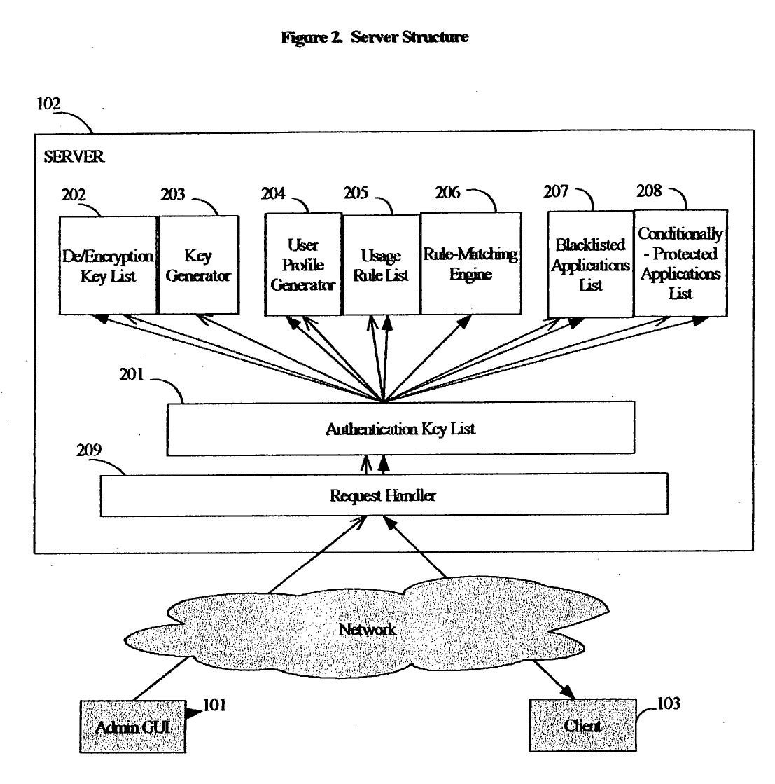

Reference is now made to FIG. 2, which is a simplified illustration of a system, residing on a server computer, for designating usage rights as well as providing decryption/encryption keys and data lists, in accordance with a preferred embodiment of the present invention.

201. Authentication Key (AK) List

The Authentication Key is an asymmetric key which client computer 103 and Admin GUI 101 use to encrypt requests to the server—both to secure the transaction itself, as well as to enable server computer 102 to verify the authenticity of the source, as compared to a hacker request. Thus, any authentication key stored on server computer 102 constitutes the server's key in what is an asymmetric, i.e. public-private key pair. The private key is stored on server computer 102—such that Clients share a common public key, or ‘certificate’; this engenders the creation of Client groups, e.g. ‘employee’ and ‘business partner’, defined by their shared certificate. In an alternative embodiment, every Client possesses its own private key, while server computer 102 maintains distinct certificates for each Client—similarly to standard PKI's.

Server computer 102 maintains list 201 of the authentication keys in circulation. Upon receiving a request, request handler 209 searches authentication key list 201 to find the appropriate decrypting key; if it succeeds in decrypting the request and the request is deemed legitimate, it is executed. Thus, it is via authentication key list 201 that client and admin requests to other server modules are processed.

Authentication key list 201 is managed via the ‘Keys’ tab (FIG. 14) in Admin GUI 101.

202. De/Encryption Key (DEK) List

In the present invention, protected information residing on a computer's hard disk is encrypted. The encryption key used for this purpose is symmetric—such that the same key is required in order to subsequently decrypt the information. In order to facilitate subsequent decryption, the Client's encrypter adds unencrypted, or, alternatively, differently encrypted meta-data prior to the encrypted information; the meta-data includes the ID of the De/Encryption Key, or ‘DEK’, that is required in order to decrypt the information.

Server computer 102 houses list 202 of DEK's, referenced by ID. Whenever client computer 103 attempts to access a protected, i.e., encrypted file, it encounters the required DEK ID, in unencrypted form, in the file's meta-data; if the required DEK is not resident on client computer 103, it requests the DEK from server computer 102, encrypting the request with its authentication key. If the request is authenticated, request handler 209 retrieves the appropriate DEK from list 202, encrypts it with its asymmetric key, and sends it to client computer 103.

One of the keys in the list may be designated as the ‘default DEK’. The default DEK is used by client computer 103 to encrypt all protected information—whether or not the information was previously encrypted with a different DEK. This provides a mechanism for regularly changing DEK's, and ensure that all Clients are working with a common key—and thus minimizing server interaction—at any given time. When a default DEK is designated, a timestamp of the event is recorded in request handler 209.

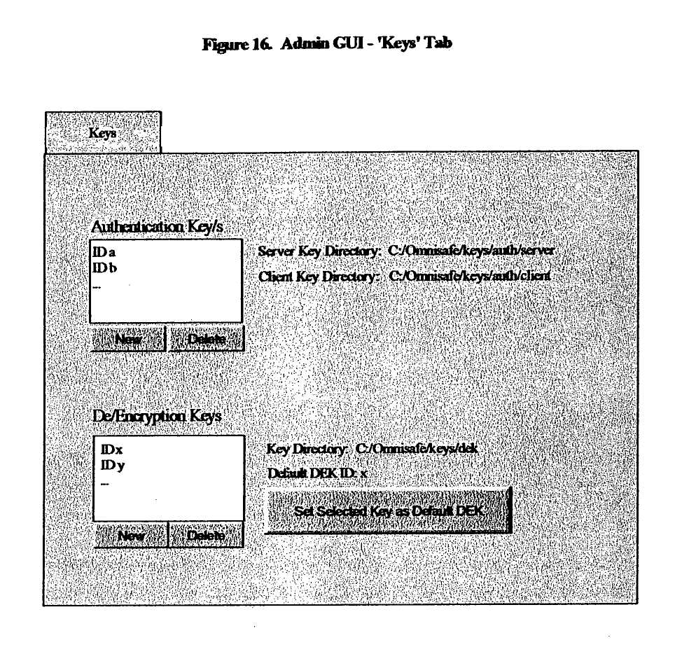

DEK list 202 is managed via the ‘Keys’ tab (FIG. 16) in Admin GUI 101.

203. Key Generator

Key generator 203 comprises the functionality that generates both symmetric and asymmetric keys, using commercially available API's from vendors such as RSA. Generated keys are placed in predefined directories, whose locations are specified via Admin GUI 101; the asymmetric key components that are designated for Client usage can be extracted from their predefined directory and subsequently bundled into customized Client installers.

Key generator 203 is launched via the ‘Keys’ tab in Admin GUI 101.

204. User Profile Generator

In the present invention, each Client possesses a ‘user profile’—a collection of any number of properties or attributes, e.g., GROUP=‘marketing’, ROLE=‘manager’, that serve as a representation of the end-user. The properties comprising the user profile are included in the request of client computer 103 for its usage rights—such that rule-matching engine 206 can calculate those rights on the basis of aspects of the user's identity, by matching the values of the provided user properties against required values that are specified in usage rule list 205.

The user profile can also be used to generate properties for the documents that end-users author. When an extension of the core architecture flags a given document for protection, as described above, it adds the Client's user properties to the meta-data that is subsequently embedded in the document by the encrypter; the properties appearing in the meta-data subsequently serve as intrinsic properties of the document. For example, where a source code file is authored by a member of the ‘engineering’ group and flagged for protection by an extension that is designed to protect source code, the property “GROUP=‘engineering’” is copied from the user properties list of the Client residing on the author's machine, and is inserted as “DOC.GROUP=‘engineering’” into the file's meta-data. The document properties that are thus formed serve to characterize the information that is protected. When incorporated into usage rules, these properties enable usage rights to be determined not only on the basis of the user, but on the basis of the information as well. For example, a rule may be constructed designating that if GROUP=‘engineering’ and DOC.GROUP=‘engineering’—i.e., the user is an engineer working with source code—the user has full rights; otherwise—i.e., the user is a member of another group such as marketing or QA—the file would be read-only.

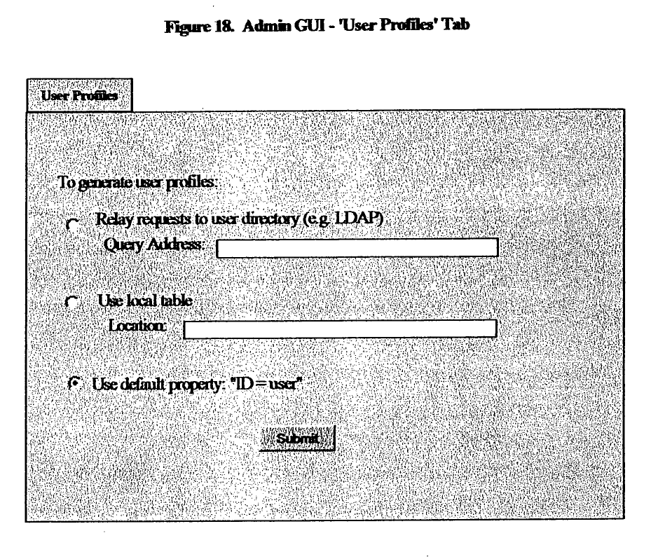

The Client's profile is constructed by user profile generator 204. Profile generator 204 is queried by Client computer 103, or alternatively, by an external utility, whenever the Client's user properties list must be re/built, e.g., following Client installation; Client computer 103 also passes a unique identifier, such as Windows login ID or user name, as a query parameter. Profile generator 204 in turn queries the user information repository specified by the ‘User Profile’ tab (FIG. 18) of Admin GUI 101; the repository may be a user directory, which the profile generator queries using LDAP or a similar protocol, or a table which the profile generator queries using SQL. In response, profile generator 204 receives the property-value pairs associated with the unique identifier, and passes these on to client computer 103. A default option, passing a dummy property-value pair “ID=‘user’” to all client computers 103, can be selected if the administrator wishes to apply a global usage rights policy, rather than one that is customizable on a per-Client basis.

When client computer 103 receives the property-value pairs comprising its profile, it stores them locally as part of its access/usage properties list.

205. Usage Rule List

In addition to protecting information from unauthorized access, the present invention enables information owners to control the manner in which that information is utilized, by enabling them to designate different levels of permitted usage for protected information, e.g., ‘read-only’ vs. ‘normal usage’, that are subsequently enforced by the Client.

The usage rights are calculated via rule list 205, which is queried by rule-matching engine 206 upon request from client computer 103. The rules map a range of usage scenarios—i.e., user x accessing document y—where properties of the user and/or of the document are the test criteria; e.g., “If ROLE=‘manager’ and DOC.GROUP=‘marketing’ . . . ”. Outcomes are specified in terms of usage rights, listed in descending stringency—‘read-only: no forwarding’/‘read-only’/‘editable: no printing’/‘editable: no transfer’/‘editable: log print jobs’/‘normal’—as well as whether information can be accessed offline; e.g., “USAGE_LEVEL=‘normal’: OFFLINE_ACCESS=‘true’”. Alternatively, offline access rights are not granted for an indefinite period, but rather for a defined interval, e.g., 24 hours; the interval is measured using the system clock of client computer 103.

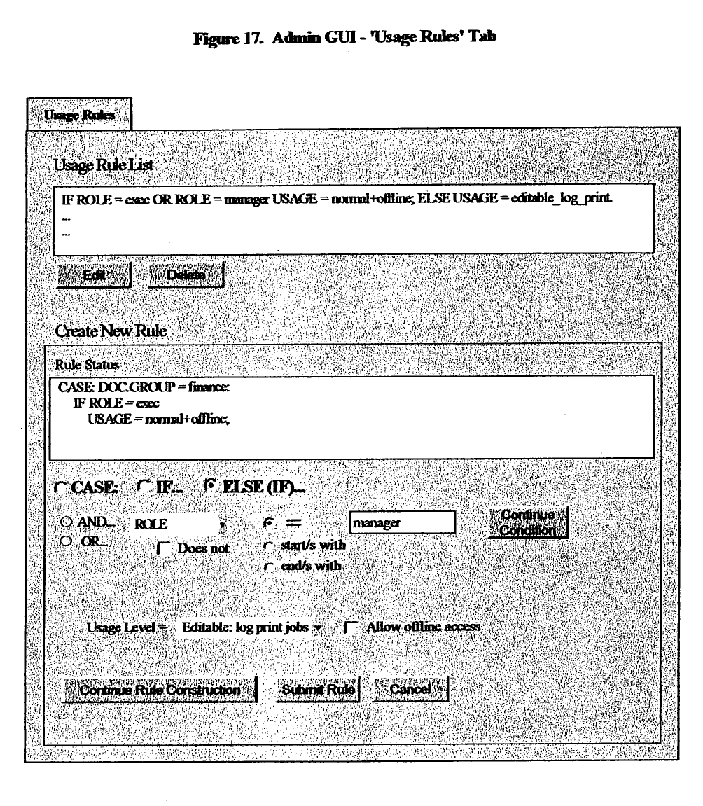

Usage rule list 205 is managed via the ‘Usage Rules’ tab (FIG. 17) in Admin GUI 101. When list 205 is modified, a timestamp of the event is recorded in request handler 209.

206. Rule-Matching Engine

Client computer 103 determines its usage rights by querying server computer 102, on cue from request handler 209. In its query, client computer 103 sends its user properties, garnered from user profile generator 204, as parameters; in an alternative embodiment, client computer 103 in its query sends its unique identifier to user profile generator 204, which then garners the user's properties and forwards them on.

The request is handled by rule-matching engine 206, which transverses usage rule list 205, using the Client's user properties as criteria in order to seek matches. Matching rules are classified into two types: ‘user-based’ rules—i.e., rules whose conditionality involves only user properties, such that the usage rights they designate can serve as default rights that are exercised when no other information is available; and ‘document-based’ rules—i.e., rules whose conditionality also includes document properties, which are not sent by client computer 103.

Where there is only one matching user-based rule, the usage rights it designates are automatically chosen as the Client's default rights. However, multiple matches may occur where rules are formulated using different subsets of Client properties—e.g., where client computer 103 sends two properties GROUP and ROLE, while Rule1 relates only to GROUP and Rule2 relates only to ROLE. In such a case, rule-matching engine 206 selects the closest match based on the number of user properties matched per rule. Where there is more than one rule bearing the highest number, the rule from this set that designates the most stringent rights is selected as the closest match. The usage rights designated by the closest match will serve as the Client's default rights. Once defined, the default rights are conveyed to client computer 103.

Unlike user-based rules, document-based rules cannot be fully matched at query time, inasmuch as the Client query does not include document properties. Therefore, engine 206 performs a ‘first pass’, by matching the Client's user properties against whatever user properties appear as criteria in document-based rules—e.g. “If ROLE=‘exec’ and DOC.GROUP=‘finance’”. Likewise, the absence of any user-based criteria is taken as a default match for all users. For any given document-based rule in which a user-match is established, engine 206 generates a trimmed version of the rule in which user-related criteria are removed, inasmuch as they have already been answered, and only conditions pertaining to document properties are retained. The trimmed, customized document rules are then sent to client computer 103—which completes the rule-matching on its end if and when it encounters document properties in the course of opening a protected document. Once the requisite rights information, comprised of default rights and document rules, is resident on the Client end, it can be used whenever protected information is being accessed.

In an alternative embodiment, client computer 103 queries server computer 102 not at defined intervals, but rather on a per-document basis—sending properties of the document in question, along with its own user properties, whenever it accesses a protected document. Rule-matching engine 206 then searches for a complete match only, designating rights for the specific document in question. In this implementation, rule-matching is not available for documents accessed offline.

In any implementation, where no match is found, client computer 103 falls back to the most stringent usage model—read-only—as a default.

207. Blacklisted Applications List

The present invention protects sensitive information by ensuring that it is encrypted when saved to disk. However, certain applications, such as email clients or ‘chat’ applications, do not normally save their data, but rather transfer it while it is still in memory to other machines. In such cases, the data could theoretically be intercepted at an intermediary node by an extension of the core architecture; for example, an email message could be intercepted at the corporate mail server by an email filter that would then protect the message. However, in some cases an extension may not be present, or may not be viable.

In order to safeguard protected information in such contingencies, the present invention ‘blacklists’ these applications: that is, the Client blocks the transfer of protected information into any of the said applications. The said applications are identified in ‘blacklisted applications’ list 207, which is stored on server computer 102, and subsequently sent to client computer 103 when its settings are re/built. The said applications are represented in list 207 via unique identifiers that appear in their binary code, such as unique strings or string patterns, or alternatively, via unique Windows API call patterns.

In an alternative embodiment, a mirror approach is used, in which list 207 contains ‘whitelisted’ applications; that is, the list is comprised of applications for which information transfer is permitted—while information transfer for any applications not appearing on list 207 is blocked.

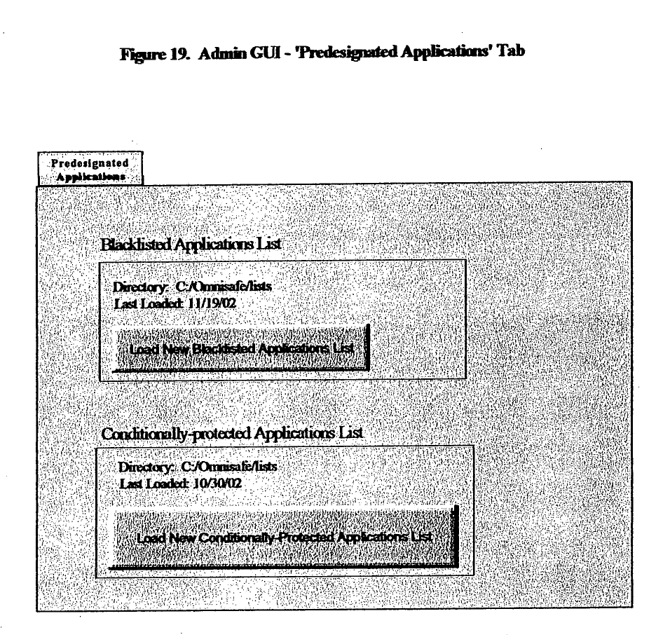

List 207 is not modifiable, but rather is stored as a shrink-wrapped module on server computer 102; where modifications are required, list 207 is replaced in its entirety. The replaced list is reloaded via the ‘Predesignated Applications’ tab (FIG. 19) of Admin GUI 101, and a timestamp of the event is recorded in request handler 209.

208. Conditionally-Protected Applications List

The general case regarding transfer of protected information is that the transfer is initiated from the protected application. For example, information is cut/copied from the protected application and subsequently pasted into the target application; similarly, information is ‘forwarded’ from the protected application to a target application. However, the transfer of information can, in some cases, be initiated from outside the protected application—most notably, via screen capture programs, which can produce a ‘snapshot’ of other application windows.

In order to safeguard protected information in this mode of transfer as well, the present invention conditionally-protects such applications; that is, it automatically flags the said applications as ‘protected’ if any other protected applications are currently running. Thus, any information saved from within the said applications, e.g., a screen-capture saved to disk, will be protected. The said applications are identified in ‘conditionally-protected applications’ list 208, which is stored on server computer 102, and subsequently sent to client computer 103 when its settings are re/built. The said applications are represented in list 208 via unique identifiers that appear in their binary code, such as unique strings or string patterns, or alternatively, via unique Windows API call patterns.

List 208 is not modifiable, but rather is stored as a shrink-wrapped module on server computer 102; where modifications are required, list 208 is replaced in its entirety. The replaced list is reloaded via the ‘Predesignated Applications’ tab (FIG. 19) of Admin GUI 101, and a timestamp of the event is recorded on request handler 209.

209. Request Handler

Request handler 209 is the I/O module that interfaces with client computer 103 and Admin GUI 101. In this capacity, it performs the following actions: decryption of Client and admin requests, with the authentication key whose ID is specified in the said requests; routing of authenticated requests to the appropriate module/s of server computer 102; and subsequent encryption and dispatching of the server response. Request handler 209 communicates with client computer 103 and Admin GUI 101 via HTTP or, alternatively, another network protocol such as CORBA.

Request handler 209 also maintains a mechanism for updating Client settings. The mechanism is based on a simple table, stored by request handler 209, which lists server settings that are utilized by client computer 103. The table contains the following entries: ‘default key’, if any has been designated, ‘usage rules’, ‘blacklisted apps’, and ‘conditionally-protected apps’—and a timestamp for each entry, representing the time on server computer 102 that the corresponding setting was last modified. At every login, or alternatively, at regular intervals, client computer 103 sends its locally-stored ‘server timestamp’ value to server computer 102, and request handler 209 then compares the Client's timestamp with those in its table. If any server settings are found to have been modified more recently than the time indicated by the Client's timestamp, request handler 209 notifies client computer 103 accordingly—and supplies it with the most recent timestamp, which becomes the Client's new ‘server timestamp’ value. Client computer 103 can subsequently request the settings that it must update.

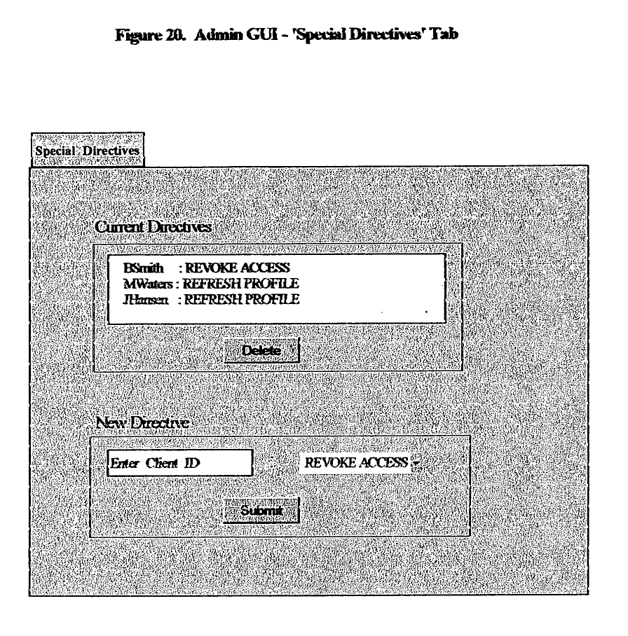

In addition, request handler 209 maintains a mechanism for issuing special directives to specific client computers 103. This mechanism is based on a second table, stored by request handler 209, which lists ID's of specific clients and a corresponding directive for each given client, e.g., ‘Refresh Profile’, or ‘Revoke Access’. If the table is non-empty, request handler 209 monitors the aforementioned Client update requests for a ‘Client ID’ parameter, which is sent by client computer 103 along with the ‘server timestamp’ value. If for any given update request, the Client ID matches an entry in its table, request handler 209 sends the directive as its response, and then purges the entry from the table. Entries are added to the table via the ‘Special Directives’ tab (FIG. 20) of Admin GUI 101.

3. Client Architecture

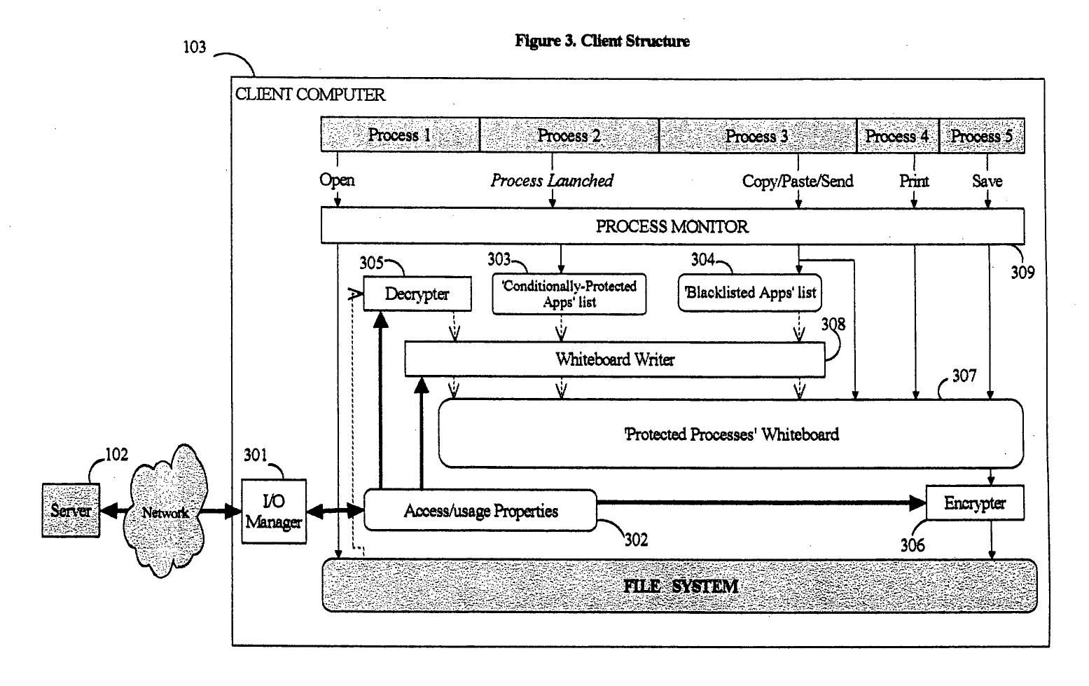

Reference is now made to FIG. 3, which is a simplified illustration of a system, residing on a client computer, for accessing protected information and enforcing the usage rights that are associated with it, in accordance with a preferred embodiment of the present invention.

301. I/O Manager

I/O manager 301 is the module that communicates with server computer 102. In this capacity, it performs the following actions: encryption of requests to a given server computer 102 with the appropriate authentication key; dispatching of said requests, along with the ID of the encrypting key, to the said server; receipt and decryption of the information that is sent in response; and writing of that information to access/usage properties list 302. I/O manager 301 communicates with server computer 102 using HTTP or alternatively, another network protocol such as CORBA

At every logon, or alternatively, at a fixed interval—e.g., once weekly—I/O manager 301 contacts server computer/s 102 that appear in access/usage properties list 302. At this regular contact, I/O manager 301 passes a ‘timestamp’ value, also appearing in access/usage properties list 302, in order to determine whether specific Client settings—usage rights, default key, blacklisted applications list 303 and conditionally-protected applications list 304—are up-to-date. Based on the value of the timestamp, server computer 102 may prompt I/O manager 301 to request those settings that require updating.

In its timestamp request, I/O manager 301 includes a unique identifier of the end-user, e.g. Windows login ID, email address, or the IP address of client computer 103. On the basis of that identifier, server computer 102 may issue a special directive to client computer 103, such as ‘Revoke Access’ or ‘Refresh Profile’. If the special directive is ‘Revoke Access’, I/O manager 301 deletes the authentication key and the properties associated with server computer 102 that appear in access/usage properties list 302. If the directive is ‘Refresh Profile’, or if access/usage properties list 302 does not contain a user profile at logon—e.g., following installation—I/O manager 301 requests the properties comprising the user profile from server computer 102; the end-user identifier is again included as a request parameter.

If I/O manager 301 has requested to update its user profile and/or usage rights and/or default key, it writes the response received from server computer 102 to access/usage properties list 302; however, predesignated applications lists sent by server computer 102 replace the existing lists in their entirety.

I/O manager 301 is subsequently invoked by decrypter 305, if the latter attempts to decrypt a protected file when the required DEK is not locally available; I/O manager 301 then requests the DEK, and subsequently adds it to the DEK list that is stored within access/usage properties list 302.

I/O manager 301 may also be invoked by process monitor 309 in order to post a print job to server computer 102, if usage rights require this.

302. Access/usage properties List

Access/usage properties list 302—read from file at Client start-up—contains information that is required by I/O manager 301 to access server computer 102, as well as information received from server computer 102 that both enables and controls access to and usage of protected information.

For any given server, the following properties appear:
Server ID—This serves as the title for the block of subsequent properties. The ID of server computer 102 appears in a protected document's meta-data, informing decrypter 305, and subsequently I/O manager 301, as to which server to query for the appropriate de/encryption key (DEK).
Server Address—Requests to the server bearing the above ID are sent to this network address by I/O manager 301.
Authorization Key ID—This is the ID of the authorization key with which I/O manager 301 must encrypt its requests to this server. The key itself is installed with the Client, or separately where a Client is already resident—and stored in a predefined ‘keys’ directory relative to the Client's installation directory. The key file is encrypted with a unique identifier, e.g., volume serial number, or a defined registry entry, so that the file is non-transferable.
Server Timestamp—This is a string which I/O manager 301 receives from the request handler of server computer 102, and which it sends to server computer 102 at every logon or alternatively, at fixed intervals; e.g., once weekly. Based on the timestamp value, server computer 102 may prompt I/O manager 301 to update Client settings, and subsequently supply I/O manager 301 with a new timestamp string.
DEK list—Here are stored the DEK'S, along with corresponding ID, that I/O manager 301 requests from server computer 102 upon instruction from decrypter 305. If a ‘default DEK’ is designated in the DEK list of server computer 102, I/O manager 301—prompted via the timestamp mechanism—requests it, stores it in this list, and flags it for subsequent usage by encrypter 306. The list has a defined maximum capacity, e.g. ten entries, and is ordered in terms of latest usage—such that infrequently-used DEK's are eventually pushed out of the list.
Usage Rights—The client's usage rights are stored here. These include an explicit designation of rights, based on the Client's user profile, that serve as a default in the absence of other directives, and/or usage rules, based on document properties, that are resolved at run-time by whiteboard writer 308 when client computer 103 accesses a protected document. Enforcement of usage rights is subsequently handled by process monitor 309. Usage rights are refreshed via the timestamp mechanism described above: if prompted by server computer 102, I/O manager 301 sends the properties comprising the Client's user profile, described below or, alternatively, a unique identifier such as Windows login ID, enabling server computer 102 to itself determine the user's profile properties. The resultant usage rights are then calculated by the rule-matching engine of server computer 102 and sent back to client computer 103.

A Client may conceivably be affiliated with a number of servers. For example, the end-user may work with documents from various departments—each of which possesses its own server; alternatively, the end-user may be a member of organization A, but also serve as a business contact for organization B, with access rights to its information. Where client computer 103 is affiliated with multiple servers in this manner, the property list detailed above is replicated for each server, creating blocks of server-specific properties in list 302. A new block is created when a new authorization key, indicating access to an additional server, is installed on client computer 103. At that time, the installer appends the server ID, server address, authorization key ID, and a dummy timestamp value of ‘0’ to access/usage properties list 302. Other properties are added subsequently via the timestamp mechanism.

Where client computer 103 is affiliated with multiple servers, one of these is flagged in properties list 302 by the Client/authentication key installer or, alternatively, by an external utility, as the ‘default server’. The default server is the one with which client computer 103 is most closely affiliated, i.e., the one that most closely represents the end-user within an organization—e.g., an ‘R&D department’ server used by employees of the R&D group. It is from the default server that client computer 103 receives ‘blacklisted applications’ list 303 and ‘conditionally-protected applications’ list 304. It is also the default server that provides client computer 103 with the end-user properties comprising the Client user profile; these properties are subsequently stored in a distinct ‘profile’ block in properties list 302. If, at logon, the Client's ‘profile’ block is empty, I/O manager 301 queries the user profile generator of the default server—sending a unique identifier such as Windows login ID or a specified registry entry, as a parameter. The properties sent back by the server are subsequently stored by the Client in its ‘profile’ block.

When client computer 103 shuts down, the access/usage properties in memory are written back to file. In an alternative embodiment, the Client's user profile is not saved to file, in order to support logins by differing users. The properties file is then encrypted, utilizing a unique identifier on the machine, e.g., volume serial number, so that the file is not transferable.

An additional property used by whiteboard writer 308 and process monitor 309 but not stored on file is an ‘online’ flag, set at login. In an alternative embodiment, server computer 102 and/or the network server are contacted at runtime by the above modules in order to determine whether client computer 103 is online at any given time.

303. Blacklisted Applications List

Blacklisted applications list 303—utilized by process monitor 309—lists applications into which protected information may not be transferred, inasmuch as the said applications are capable of forwarding protected information in memory directly to unauthorized machines. The applications themselves are identified by unique strings or Windows API call patterns found in their binary code. In an alternative embodiment, list 303 is comprised of ‘whitelisted’ applications—that is, the applications appearing in the list are the only ones for whom information transfer is permitted. Client computer 103 receives list 303 from its default server, designated in access/usage properties list 302; the default server prompts I/O manager 301 to refresh list 303 as needed via the timestamp mechanism, also represented in access/usage properties list 302. Similar prompts from non-default servers are ignored.

304. Conditionally-Protected Applications List

Conditionally-protected applications list 304—utilized by process monitor 309—lists applications that are capable of reproducing protected information found in other processes, e.g., screen capture programs, which can create snapshots of protected process windows. The applications appearing in the list are therefore automatically designated as protected if other protected processes are running. The applications themselves are identified by unique strings or Windows API call patterns found in their binary code. Client computer 103 receives list 304 from its default server, designated in access/usage properties list 302; the default server prompts I/O manager 301 to refresh list 304 as needed via the timestamp mechanism, also represented in access/usage properties list 302. Similar prompts from non-default servers are ignored.

305. Decrypter

Decrypter 305 is the module that enables access to protected information. It is invoked by process monitor 309 when the Windows operating system attempts to read file information from disk or from a stream, i.e., over a network. If the information in question does not begin with the string “*PROTECTED/” or, alternatively, a similar flag, decrypter 305 informs process monitor 309 that the information is not protected. If the flag is present, indicating the presence of meta-data previously embedded by encrypter 306, decrypter 305 reads the unencrypted portion of the meta-data. The unencrypted portion lists the ID of the DEK that is required in order to decrypt the remaining information, and the ID of the server from which the DEK can be requested. If the DEK is already stored locally in access/usage properties list 302 of client computer 103, decrypter 305 retrieves it from there; otherwise, it prompts I/O manager 301 to request the DEK from specified server 102.

Once the required DEK is available, decrypter 305 decrypts the remainder of the meta-data segment, whose end is signified by the string “/PROTECTED*” or, alternatively, a similar flag. Decrypter 305 then sends the fully-decrypted meta-data string, minus the ‘start’ and ‘end’ flags, to process monitor 309, which forwards it to whiteboard writer 308 in order to determine the access/usage rights associated with the document. If process monitor 309 does not instruct decrypter 305 to halt, signifying that access has been denied, decrypter 305 proceeds to decrypt the file information itself. It subsequently passes the information to process monitor 309 when the decryption is complete.

306. Encrypter

Encrypter 306 is the module that actually protects information that is designated for protection. Encrypter 306 is invoked by process monitor 309 when the Windows operating system seeks to save information in a protected process to disk or to a remote computer. Encrypter 306 receives from process monitor 309 the file information, as well as the following parameters: ‘Server ID’, ‘encrypting DEK ID’, and ‘meta-data’ values, retrieved by process monitor 309 from the whiteboard record corresponding to the process in question. Encrypter 306 locates and retrieves the specified DEK from the DEK list that is stored in access/usage properties list 302. It then generates a meta-data string, concatenating the following sub-strings: [start flag], [‘Server ID’ value], [‘DEK ID’ value], [‘meta-data’ value], [end flag]. The generated string is then embedded as a header to the file information. Finally, encrypter 306 encrypts the information using the specified DEK—beginning from the [‘meta-data’ value] substring, such that the [start flag], [‘Server ID’ value], and [‘DEK ID’ value] strings remain unencrypted. When encryption is complete, encrypter 306 passes the information back to process monitor 309.

307. Protected Processes Whiteboard

Protected processes whiteboard 307 is a table that lists the processes, currently running on the end-user's machine, that have been flagged as ‘protected’ by whiteboard writer 308. Each record in the table includes the following fields:
ID—the unique identifier for the record, consisting of the process ID and preferably also the handle of the window running in the process. The appending of the window handle to the ID enables unique records to be created for multiple documents that are managed within a single process, such that support is provided for Multiple Document Interface, or ‘MDI’ applications;
Conditionally Protected—a flag indicating whether the process has been launched by a conditionally-protected application;
Usage Rights—usage rights associated with the process, as determined by whiteboard writer 308;
Encrypting DEK—the ID of the DEK that will be used by encrypter 306 when information from the process is saved to disk;
Server—the ID of the server from which the DEK originates; and
Meta-data—meta-data other than DEK and server ID, e.g., document properties that have been embedded in the file accessed by this process.

Whiteboard 307 is accessed by whiteboard writer 308 and process monitor 309.

308. Whiteboard Writer

Whiteboard writer 308, as denoted by its name, writes to protected processes whiteboard 307—adding new records when given processes become designated as ‘protected’, modifying fields within records when the usage rights associated with a given protected process change, and deleting records when protected processes shut down, or lose their ‘protected’ designation. Writer 308 also possesses a ‘rights-calculation engine’ that determines usage rights for new records and updates rights for existing records when whiteboard 307 is modified.

All actions of whiteboard writer 308 are initiated by process monitor 309. In initiating a writer action, process monitor 309 passes it the ID of the target process, preferably appending to the process ID the handle of the window and/or the ID of the thread from which the monitored function was called. Process monitor 309 also passes writer 308 additional parameters, which vary according to the nature of the given action.

Where a new record is to be added because the target process is accessing a protected document, the additional parameters are a flag indicating whether the process is conditionally-protected, as determined by conditionally-protected applications list 304, and the document's meta-data string, embedded in the document by encrypter 306. Whiteboard writer 308 receives these parameters, and copies the ‘conditionally-protected’ flag to the corresponding field in the new record. It garners the server ID from the meta-data string, and sets that value in the corresponding field. If the specified Server possesses a default DEK, writer 308 sets its ID as the value in the ‘encrypting DEK’ field; otherwise, it garners that value from the meta-data string. The remainder of the meta-data string is then written to the record's ‘meta-data’ field.

If the ‘ID’ parameter passed by process monitor 309 is already being used by an existing record—e.g., indicating that the currently-accessed file is in fact being embedded in an already-protected process—writer 308 creates a temporary record with a dummy ID for the new file, and then applies the algorithm described below for managing the transfer of protected information from one process to another.

The usage rights for the new process, which are entered in the ‘usage rights’ field of the new record, are determined by the rights-calculation engine of whiteboard writer 308. If the document's meta-data includes a volume serial number or, alternatively, an IP address that does not match that of the end-user's machine, the engine deletes the record and informs process monitor 309, and the document will not load. Similarly, the document's meta-data may include an ‘expiration date’. The engine determines whether that date has passed by consulting the system clock, or alternatively, by sending the ‘date’ string to server computer 102 to verify in a tamper-free manner. If the date has passed, the engine deletes the record, informs process monitor 309, and the document will not load.

If there is no constraint denying access, the engine examines the meta-data for rights information. If the document's meta-data explicitly designates rights, the engine applies those rights to the process. Otherwise, the engine consults the document's meta-data, and the Client's usage rights, which are stored in access/usage properties list 302. If the document's meta-data does not include any document properties, or if the usage rights do not include any document-based rules, the Client's default usage rights are applied to the process. Otherwise—i.e., both document properties and document-based rules are present—the engine compares those properties against all the rules in order to seek a match.

The rule-matching uses the following criteria: if a given document property bears multiple values, e.g., “GROUP=‘development’/‘marketing’”—which can occur if information from different documents is pooled into one document, as described below—the multiple values are treated as alternatives (Boolean ‘OR’) in the rule-matching process. If multiple matches occur—inasmuch as all the listed rules are consulted in the match-seeking process—the engine selects the closest match based on the number of properties matched. Where there is more than one such match, the rule from this set that designates the most stringent rights is selected as the closest match. If no match is made, the most stringent rights—read-only with no forwarding—are applied.

If the usage rights associated with the process, as determined by the engine, do not permit offline access, writer 308 verifies that client computer 103 is currently online. Verification is performed by consulting an ‘online’ flag in access/usage properties list 302 that is set at login, or alternatively, by pinging server computer 102 or the network server. If client computer 103 is offline, writer 308 notifies process monitor 309 accordingly, and the data will not load. Otherwise, the rights designation is entered in the ‘usage rights’ field of the new record. If the designated rights are more stringent than those assigned to other processes, writer 308 updates the ‘usage rights’ field for any conditionally-protected processes, to ensure that they too now possess the stringent rights. If the designated rights do not permit forwarding, writer 308 appends the volume serial number or, alternatively, the IP address of the end-user's machine to the string in the record's ‘meta-data’ field.

Where a new record is to be added because a conditionally-protected process has now been designated as ‘protected’, the additional parameter from process monitor 309 is a ‘true’ flag. Writer 308 sets the value of the ‘conditionally-protected application’ field to ‘true’, sets the value of the ‘Server’ field to the ID of the default Server, as designated in access/usage properties list 302, and writes the ID of that Server's default DEK to the ‘encrypting DEK’ field. If a default DEK has not been designated for that Server, the ID of the first key in its DEK list is utilized. Writer 308 sets the value of the ‘usage rights’ field to the most stringent level appearing currently in whiteboard 307.

Where a record is to be added or modified because the target process has received information from another protected process, e.g., via the Windows clipboard or programmatic forwarding, the additional parameter is the ID of the source process. If the target process does not yet possess its own record, writer 308 creates one for it—using the target process ID received from process monitor 309, and copying all other field values from the record corresponding to the source process. If the target process already possessed its own record, writer 308 queries the source record and performs the following actions: it compares the designated usage rights in the two records and sets the more stringent of the two for the target record. If the source record possesses a meta-data string, writer 308 rewrites the corresponding string of the target record to include the values of the source record's string, using the following rules: if the meta-data string in either record contains embedded rights information, the most stringent version is preserved; if the meta-data in either record contains document properties, these are combined, such that a given document property may conceivably acquire multiple values. If the target record does not yet have an entry in its ‘encrypting DEK’ field, the source record's ‘Server’ and ‘encrypting DEK’ values are written to the corresponding fields of the target record.

Where a record is to be deleted, the additional parameter is a string ‘delete’; whiteboard writer 308 then deletes the record bearing the specified process ID. If all the remaining records in the whiteboard represent conditionally-protected processes, those records are subsequently deleted as well. Otherwise, if the deleted record bore the most stringent usage rights in whiteboard 307, the next-most-stringent rights that appear are set in the ‘usage rights’ fields of conditionally-protected processes.

309. Process Monitor

Process monitor 309 is the engine that drives and coordinates all of the Client's activities; it drives the decryption and encryption of protected information, determines which processes are to be protected, drives the designation of rights for those processes via whiteboard writer 308, and subsequently enforces the usage rights that have been designated.

Process monitor 309 is comprised of two primary mechanisms that intercept selected function calls of the Windows operating system, and identify the processes, windows and preferably also the threads from which the calls originate. Low-level function calls are intercepted by a kernel-mode device driver. In order to intercept higher-level, ‘user-level’, calls, process monitor 309 performs run-time ‘patching’ of Windows DLL files—i.e. overwriting Windows code that has been loaded into memory—in order to selectively modify specified functions. The patched DLL files, such as ‘user32.dll’, are then injected into all running processes—enabling the process and window that call a given function to be readily identifiable. In an alternative embodiment, Windows functions are intercepted solely via the patching mechanism. In another alternative embodiment, functions are intercepted solely by the driver, while additional user-level information is obtained by querying a DLL that is injected into all running processes. The functions that are intercepted, via driver and/or DLL patching, are then modified, blocked, or allowed to continue unimpeded—as per the requirements associated with the calling process or window.

Process monitor 309 intercepts Windows functions such as ReadFile that are called when file information is read from disk, e.g., when a user opens a file, or when s/he seeks to embed a file within a running process via ‘drag-and-drop’. Similarly, process monitor 309 intercepts Windows functions such as ReadStream that read file information over a network. Process monitor 309 then invokes decrypter 305 in order to determine whether the file in question is protected, i.e., encrypted. If process monitor 309 is informed that the file is not protected, it allows the file-reading functionality to proceed normally. If the file is protected, process monitor 309 receives the file's meta-data. It then creates an ID value by concatenating the ID of the calling process, the handle of the calling window, and preferably the ID of the calling thread. It then passes the ID value and the meta-data to whiteboard writer 308, which determines access/usage rights. If writer 308 determines that the file may not be accessed, process monitor 309 blocks further file reading and displays an error dialog. If the file may be accessed, process monitor 309 receives the decrypted file information from decrypter 305 and passes it to the file-reading function.

Process monitor 309 also intercepts Windows functions such as WriteFile that save file information to disk on the local computer, and functions such as WriteStream that save file information to a remote computer. Process monitor 309 consults whiteboard 307 to determine whether the calling process has been flagged as ‘protected’—and if so, whether or not usage rights permit saving changes, i.e., whether the information is read-only. If the process is not protected, process monitor 309 allows the file-saving functionality to proceed normally. If it is protected and read-only, process monitor 309 blocks the file-saving function and displays an error dialog. If it is protected and editable, such that changes may be saved to disk, process monitor 309 invokes encrypter 306, passing it the appropriate parameters from whiteboard 307. After encrypter 306 adds the required meta-data and encrypts the information, process monitor 309 passes the information back to the calling function.

The launching and shutting down of Windows processes is also detected by process monitor 309. When a new process is launched, process monitor 309 scans the application code that is loaded into memory in order to determine whether that application appears in conditionally-protected applications list 304. If not, it takes no action; if the application does appear in the list, it stores the process ID locally. If whiteboard 307 is non-empty, indicating that protected processes are currently running, process monitor 309 then notifies whiteboard writer 308 to add a new record, and sends as parameters the ID of the process and a flag indicating that the process was launched by a conditionally-protected application. Similarly, when a first protected process is registered in whiteboard 307, process monitor 309 passes any stored conditionally-protected process ID's along with a ‘conditionally-protected’ flag to whiteboard writer 308, and instructs it to add new records. Likewise, when a process shuts down, process monitor 309 checks whiteboard 307 to determine whether the ID of that process appears there; if it does, process monitor 309 instructs whiteboard writer 308 to delete the corresponding record. If the ID of the process is also stored with process monitor 309, it is deleted from there as well.

Windows functions that send process data to external devices for printing, such as TextOut, are also intercepted by process monitor 309. Upon interception of the function call, process monitor 309 verifies that client computer 103 is currently online. Verification is performed by consulting an ‘online’ flag in access/usage properties list 302 that is set at login, or, alternatively, by pinging server computer 102 or the network server. If client computer 103 is offline, process monitor 309 blocks the print job, and an error dialog is displayed to the user. Otherwise, process monitor 309 consults whiteboard 307 in order to determine whether the calling process is protected—and if so, whether printing is permitted. If the process is not protected or if the usage rights associated with the process allow printing to take place freely, process monitor 309 allows the print job to proceed normally. If the usage rights stipulate that print jobs must be logged, process monitor 309 notifies I/O manager 301, passing it any relevant information, e.g., a ‘Document ID’ that may be implanted in the meta-data by an extension of the core architecture. I/O manager 301, adding the unique identifier of the user, then posts the print job to server computer 102. If printing is not permitted, the print job is blocked, and an error dialog is displayed to the user.

Process monitor 309 tracks not only the access/usage of information within processes, but also the flow of information across processes, or across windows, in MDI applications—enabling control to be maintained over protected information even when it is reproduced and transferred to a new location. Process monitor 309 tracks information that is transferred via the Windows clipboard by intercepting functions that access clipboard information, such as GetClipboardData, as well as those that modify clipboard information, such as SetClipboardData. Process monitor 309 also detects the execution of Windows ‘Print Screen’ functionality, which copies pixels from the screen and places them on the clipboard. When a change occurs in the state of the clipboard, generated by a ‘Cut/Copy’ command from within the active window, or an <ALT>‘Print Screen’ key press, which produces a snapshot of the active window, process monitor 309 obtains the handle of the active window. It then consults whiteboard 307 in order to determine whether the corresponding process is protected; if it is, process monitor 309 sets an internal ‘clipboard status’ flag to ‘protected’, and it stores the ID of the corresponding record.

A variant of the above behavior occurs when the clipboard data is set by a simple ‘Print Screen’ key press, which produces a snapshot of the entire screen. In that case, process monitor 309 identifies the currently-open windows, and consults whiteboard 307 as to their protection status. If any are protected, it sets the ‘clipboard status’ flag to ‘protected’, and from among the protected windows that are open, it stores the ID of the one possessing the most stringent rights.

When clipboard information is accessed (‘Paste’), process monitor 309 checks the status of the clipboard flag. If it is not set to ‘protected’, process monitor 309 does not interfere with the ‘Paste’ operation. If it is set to ‘protected’, process monitor 309 consults ‘blacklisted applications’ list 303 to determine whether the calling process is blacklisted. If it is, process monitor 309 blocks the operation and displays an error dialog. If the process is not blacklisted, process monitor 309 consults whiteboard 307 to determine the usage rights associated with the stored ID. If transfer of information is not permitted, e.g. the information is designated as read-only, or as editable only within its own process or window but the process or window accessing the information possesses a different ID, process monitor 309 purges the clipboard and displays an error dialog. Otherwise, it passes the stored ID of the source record, along with the ID of the destination process/window, to whiteboard writer 308.

Similarly, process monitor 309 intercepts functionality that programmatically forwards information to other processes, presented to the user as ‘Send to . . . ’ functionality. This interception is effected by capturing Windows ‘WM_COPYDATA’ messages or, alternatively, intercepting COM forwarding functions that are called when pipes to other processes are established. Process monitor 309 then consults whiteboard 307 to determine whether the calling process is protected. If it is not, process monitor 309 does not interfere with the forwarding operation. If it is protected, process monitor 309 consults ‘blacklisted applications’ list 303 to determine whether the destination process is blacklisted. If it is, process monitor 309 blocks the operation and displays an error dialog. If the destination process is not blacklisted, process monitor 309 determines the usage rights that are associated with the calling process. If transfer of information is not permitted, e.g., the information is designated as read-only, or as editable only within its own process or window, process monitor 309 blocks the operation and displays an error dialog. Otherwise, process monitor 309 passes the ID of the corresponding record, along with the ID of the process/window into which the information is being transferred, to whiteboard writer 308.

4. Updating Client Settings

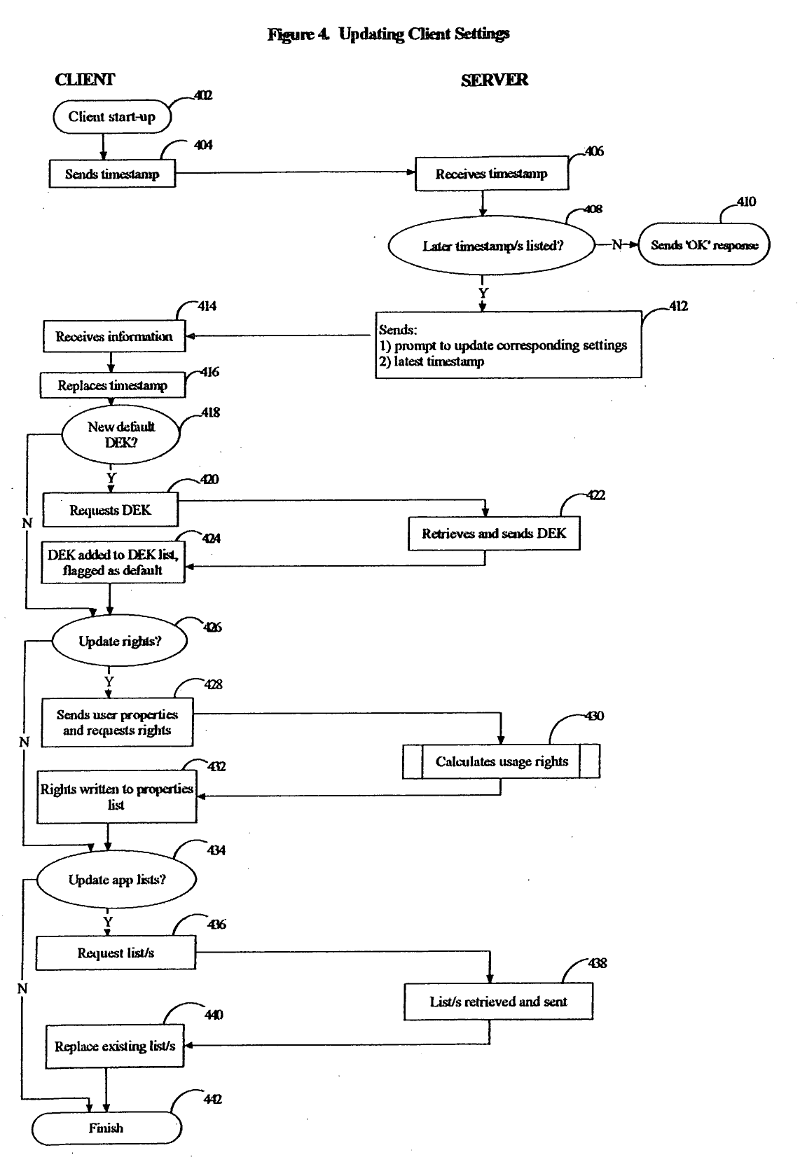

Reference is now made to FIG. 4, which is a simplified flowchart of a method for updating Client settings, in accordance with a preferred embodiment of the present invention. The flowchart is divided into two columns; the left column represents actions that are taken by the Client, and the right column represents actions that are taken by the Server.

At step 402, the Client starts up and logs onto the network; alternatively, a predefined interval—e.g. one week—passes. At step 404, the Client's I/O manager consults the access/usage properties list to identify the Server/s with which the Client is affiliated, as well as the address and the authentication key required to contact the Server/s. The access/usage properties list also contains a timestamp value for each Server; the I/O manager retrieves this value, encrypts it with the Server's authentication key, and sends it to the Server's address.

At step 406, the Server's request handler receives the timestamp, decrypts it and authenticates the user. At step 408, the request handler compares the Client's timestamp with the timestamp values stored on its end, corresponding to the dates on which the Server's default DEK, usage rule list, ‘Blacklisted Applications’ list, and ‘Conditionally-protected Applications’ list respectively were last updated. The comparison determines whether any of the dates are more recent than the one appearing in the Client's timestamp, indicating that the Client does not possess the most up-to-date settings. If there are no later dates, at step 410 the request handler returns an ‘OK’ response to the Client—and thus ends the interaction. If there are any later dates in the request handler's timestamp values, at step 412 the request handler sends the Client a prompt, encrypted with the Server's authentication key, to update the settings corresponding to the more recent timestamp values. It also sends the most recent timestamp itself.

At step 414, the I/O manager receives and decrypts the information, and at step 416 it uses the timestamp received from the Server to replace the old timestamp value appearing in the Server's block in the access/usage properties list. At step 418 the I/O manager examines the Server response to determine whether it includes the ID of a new default DEK that the Client is prompted to request. If it does not, the I/O manager skips to step 426. If it does, at step 420 the I/O manager sends a request, encrypted with its authentication key, for the DEK bearing the specified ID. At step 422 the request handler receives and decrypts the request. It then retrieves the DEK from the Server's DEK list and sends the DEK, encrypted with its authentication key, to the Client. At step 424 the I/O manager receives and decrypts the DEK, and subsequently adds it to the DEK list that is part of the Server's block in the access/usage properties list. It then flags the DEK as the default for this Server. If the Client already possesses the DEK in question, it simply flags it as the default.

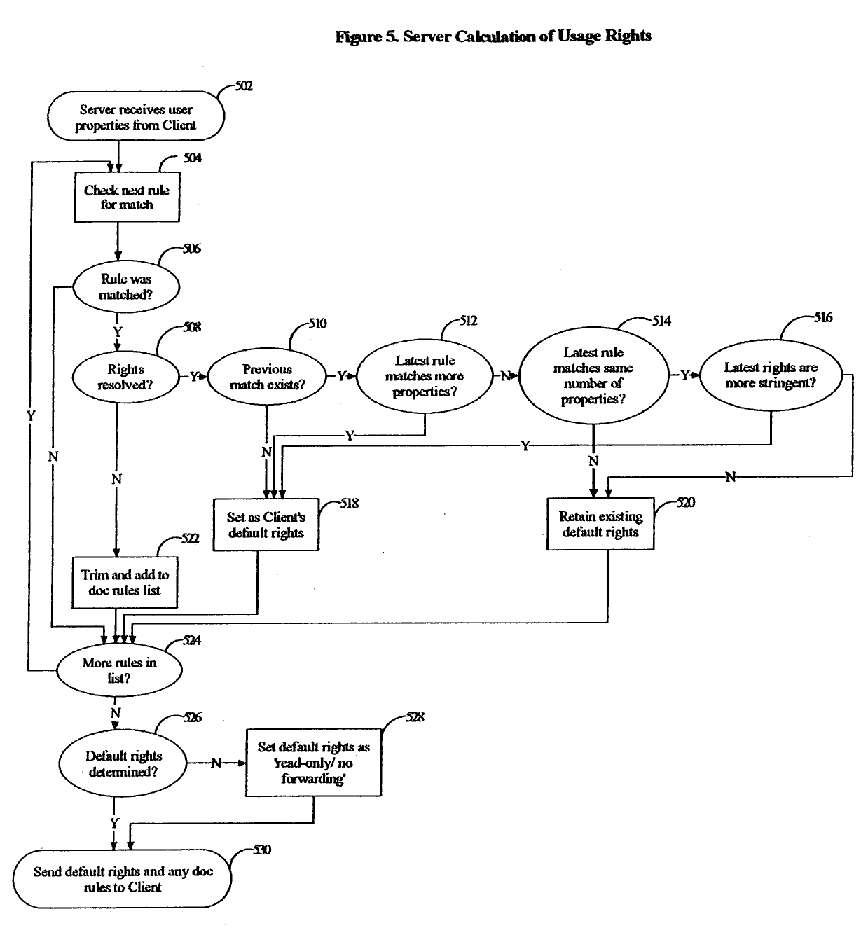

At step 426 the I/O manager examines the Server response to determine whether it includes a prompt to refresh usage rights. If it does not, the I/O manager skips to step 434. If it does, at step 428 the I/O manager retrieves the Client's user properties from the access/usage properties list, and sends them, encrypted with its authentication key, to the Server. At step 430 the Server receives the properties, calculates the Client's usage rights, as described in FIG. 5, and sends back the response, encrypted with its authentication key. At step 432, the I/O manager receives the response, decrypts it, and writes the usage rights information in the block corresponding to this Server in the access/usage properties list.

At step 434, the I/O manager examines the Server response to determine whether it includes a prompt to replace the ‘Blacklisted Applications’ list and/or the ‘Conditionally-protected Applications’ list. If it does not, the I/O manager skips to step 442. If it does, at step 436 the I/O manager sends the Server a request for the specified list/s, encrypted with its authentication key. At step 438, the Server receives and decrypts the request, retrieves the list/s, and sends back the information, encrypted with its authentication key. At step 440, the I/O manager receives the response, decrypts it, and replaces the existing list/s on the Client end with the new list/s sent by the Server.

Step 442 signifies the completion of the updating process.

5. Calculation of Client Usage Rights

Reference is now made to FIG. 5, which is a simplified flowchart of a method for determining the usage rights that are designated for a given Client, in accordance with a preferred embodiment of the present invention. At step 502, the Server's request handler receives a Client's user properties in the context of a request to refresh usage rights, driven by the timestamp mechanism illustrated in FIG. 4. It then passes these on to the Server's usage rule-matching engine. The engine will iterate through the Server's usage rule list, comparing the property values against the required criteria in any given rule, in order to find matches.

At step 504, the engine begins a new iteration, examining the next rule in the list, i.e., the first rule if the rule-matching process has just begun. At step 506, the engine determines whether a match has been found—where a match is defined as a situation in which the values of the Client's properties match the required values specified for any of those properties within a given rule. For example, where the Client has sent two property-value pairs—“GROUP=‘R&D’; ROLE=‘manager’”—and the currently-examined rule is “If ROLE=‘manager’ USAGE=‘normal’”, a match will be found, inasmuch as the rule referred to one of the two Client properties (‘ROLE’), and the required value for that property (‘manager’) was matched by the Client. If the rule was not matched, e.g. the value of the Client's ROLE property was ‘employee’, the engine skips to step 524.

If a match was found, the engine proceeds to step 508, in which the engine determines whether the match was complete—i.e., whether all criteria in the rule were satisfied, allowing the usage rights outcome to be resolved—or whether the match was incomplete, inasmuch as the rule includes in its criteria properties that are not sent by the Client, such that the rights outcome could not be resolved. This latter scenario will be the case where the administrator creates a ‘document-based’ rule: that is, a rule which specifies required values for document properties alone, or in conjunction with user properties; e.g., “If DOC.GROUP=‘finance’ and ROLE=‘exec’, USAGE=‘normal; else, USAGE=‘read-only’”.

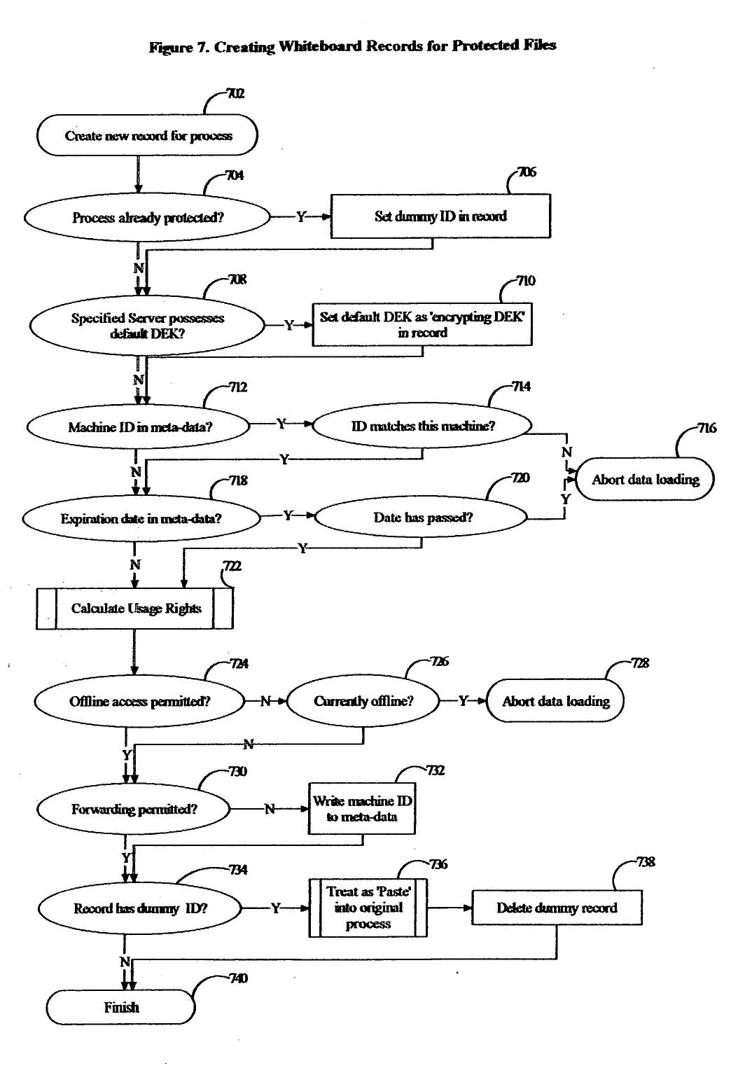

If the rights are not resolved, the engine proceeds to step 522, where it trims the portion of the rule that has already been matched—leaving the rest of the rule to be matched by the Client at run-time when it opens protected documents (as illustrated in FIG. 7). Thus, in the above example, if the user's ROLE is ‘employee’, the rule will be trimmed to a simpler statement “If DOC.GROUP=‘finance’, USAGE=‘read-only’. The customized, document-based rule is then stored along with any other such document-based rules that are generated by the engine as it iterates through the usage rule list. The engine then proceeds to step 524.

If usage rights are resolved, i.e., the rule was fully matched, the engine proceeds to step 510 in which it determines whether a complete match has already been found in an earlier iteration and stored. If not, the engine proceeds to step 518. If a previous match has already been stored, the engine proceeds to step 512, in which it determines whether the current rule has matched more properties than the stored match—such that the current rule more accurately reflects the rights that are appropriate for the user. If the current rule matches more properties, the engine proceeds to step 518. If not, the engine proceeds to step 514, in which it determines whether the current rule matches at least the same number of properties as the stored match. If not, i.e., the current rule in fact matches less properties, the engine proceeds to step 520. If the current rule matches the same number of properties, the engine proceeds to step 516, in which it determines whether the rights designated by the current rule are more stringent than those designated by the stored match. If they are, the engine proceeds to step 518. If they are not, the engine proceeds to step 520.

At step 518, the engine discards the stored rule and instead stores the current rule for subsequent comparisons, while the rights designated by the current rule serve as the Client's default usage rights; i.e., the rights that are applied when no other directives are indicated in a protected document's meta-data. The engine then proceeds to step 524.

At step 520, the engine discards the current rule and retains the stored matching rule for subsequent comparisons, while the rights designated by the rule serve as the Client's default usage rights; i.e., the rights that are applied when no other directives are indicated in a protected document's meta-data. The engine then proceeds to step 524.

At step 524, the engine determines whether there are any more unexamined rules in the usage rule list. If there are, the engine returns to step 504 for a new rule-matching iteration. If there are no more rules, the engine proceeds to step 526, in which it determines whether default usage rights have been designated for the Client. If they have, the engine proceeds to step 530. If default rights have not been designated, e.g. if only document-based rules have been defined, or if the rule list has been emptied, the engine at step 528 sets the most stringent rights—‘read-only/no forwarding’—as the Client's default usage rights.

At step 530, the engine forwards the default rights and any document-based rules to the request handler, which encrypts the rights information with its authentication key and sends it to the Client.

6. Reading Protected Files

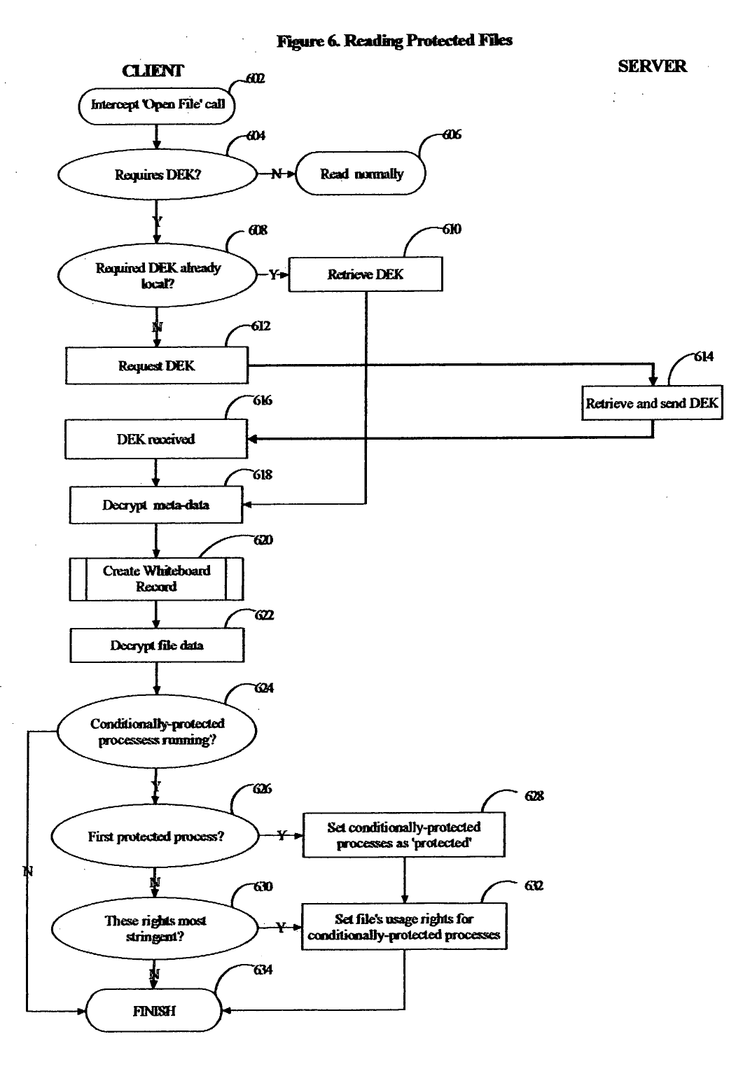

Reference is now made to FIG. 6, which is a simplified flowchart of a method for reading protected files, in accordance with a preferred embodiment of the present invention. The flowchart is divided into two columns; the left column represents actions that are taken by the Client, and the right column represents actions that are taken by the Server.

At step 602, a local or remotely-residing file is opened within a given process on the Client computer—e.g., where the user has selected ‘Open File’, or where s/he is embedding a file in another process. At step 604, the Client's process monitor intercepts the Windows file-reading call, e.g. ReadFile or ReadStream, and invokes the Client's decrypter. The decrypter then examines the first bytes of the file data in order to determine whether the file begins with meta-data specifying the ID of the DEK that is required to decrypt the subsequent file data, as well as the ID of the Server at which the DEK can be obtained. If the file does not begin with meta-data—i.e., it is an unprotected file—the decrypter informs the process monitor, which proceeds to step 606—stepping back and allowing the normal Windows file-reading functionality to execute.

If the file does begin with meta-data, the decrypter proceeds to step 608—consulting the Client's access/usage properties list in order to determine whether the required DEK is already stored locally in the DEK list associated with the specified Server. If it is, the decrypter at step 610 retrieves the required DEK, and then skips to step 618. If the required DEK is not stored locally, the decrypter proceeds to step 612, in which it requests the specified DEK from the specified Server, encrypting the request with its authentication key. At step 614 the Server's request handler receives and decrypts the request. It subsequently retrieves the requested DEK from the Server's DEK list, encrypt it with its authentication key, and sends it back to the Client. At step 616 the Client's I/O manager receives and decrypts the information, and adds the DEK to the DEK list associated with the specified Server in the access/usage properties list. The DEK is now available for the decrypter, which proceeds to step 618.

At step 618, the decrypter decrypts the encrypted portion of the file's meta-data, i.e., until reaching a recognized flag that signifies the end of the meta-data string. It then passes the meta-data to the process monitor. At step 620 the process monitor forwards the meta-data and process information to the whiteboard writer, which create a whiteboard record for the process accessing the file (as illustrated in FIG. 7). At step 622 the decrypter decrypts the remainder of the data, i.e., the file information itself, and passes it via the process monitor to the calling process.

At step 624, the process monitor consults its locally-stored list of conditionally-protected process ID's in order to determine whether conditionally-protected processes are currently running. If the list is empty—i.e., if no conditionally-protected processes are running—the process monitor skips to step 634. If there are conditionally-protected processes running, at step 626 the process monitor determines whether the current process is the first to be protected—i.e., whether the current process is the only one currently registered in the whiteboard. If it is, at step 628 the process monitor forwards the ID's of the conditionally-protected processes from its local list to the whiteboard writer, which subsequently registers the processes in the whiteboard and proceeds to step 632.

If other protected processes have already been running—such that any conditionally-protected processes have already been registered in the whiteboard—the writer at step 630 determines whether the rights designated for the current process are the most stringent appearing in the whiteboard. If they are not, such that conditionally-protected processes already possess more stringent rights, the writer proceeds to step 634. If they are the most stringent rights, the writer proceeds to step 632.

At step 632, the writer sets the usage rights designated for the current process as the rights for the conditionally-protected processes.

Step 634 signifies the end of the procedure.

7. Creating Whiteboard Records for Protected Files

Reference is now made to FIG. 7, which is a simplified flowchart of a method for creating a whiteboard record for a Client computer process opening a protected file, in accordance with a preferred embodiment of the present invention. At step 702 the Client's process monitor passes the following parameters to the whiteboard writer: an ID value generated by concatenating the ID of the process, the handle of the window, and preferably, the ID of the thread opening the file; the file's meta-data, received from the decrypter; and a flag indicating whether the process is conditionally-protected, i.e., whether the application which launched the process appears in the Client's ‘conditionally-protected applications’ list. The writer uses these parameters to create a new record for the process in the protected processes whiteboard—effectively registering’ it as a protected process.

At step 704 the writer determines whether the process is already protected—which may occur, for example, if the user is currently accessing a protected file in order to embed it within the process via drag-and-drop. The writer makes this determination by checking whether a record already exists possessing the ID that is intended for the new record. If another such record already exists, at step 706 the writer places a dummy ID in the current record. At step 708, the writer determines whether the Server that is specified in the file meta-data has a designated default DEK, by consulting the DEK list affiliated with this Server in the access/usage properties list. If one of the keys in this list has been flagged as the Server's default DEK, at step 710 the writer enters the ID of the DEK in the record's ‘encrypting DEK’ field.

At step 712 the writer searches the meta-data for a ‘Machine ID’ property, listing a computer volume serial number or, alternatively, an IP address. If no such property appears in the meta-data, the writer proceeds to step 718. If it does appear, at step 714 the writer examines the value that is specified for ‘Machine ID’. If the value matches the ID of the Client computer, the writer proceeds to step 718. If the value does not match, at step 716 the writer informs the process monitor that the file in question may not be opened on this machine. The process monitor then aborts the file-reading, and displays an error dialog to the user.

At step 718 the writer searches the meta-data for an ‘expiration date’ property. If no such property appears, the writer proceeds to step 722. If it does appear, at step 720 the writer determines whether the listed date has already passed by consulting the system clock, or alternatively, by sending the ‘expiration date’ value to the Server in order to verify the date in a tamper-proof manner. If the date has passed, the writer proceeds to step 716, above. If it has not passed, the writer proceeds to step 722.

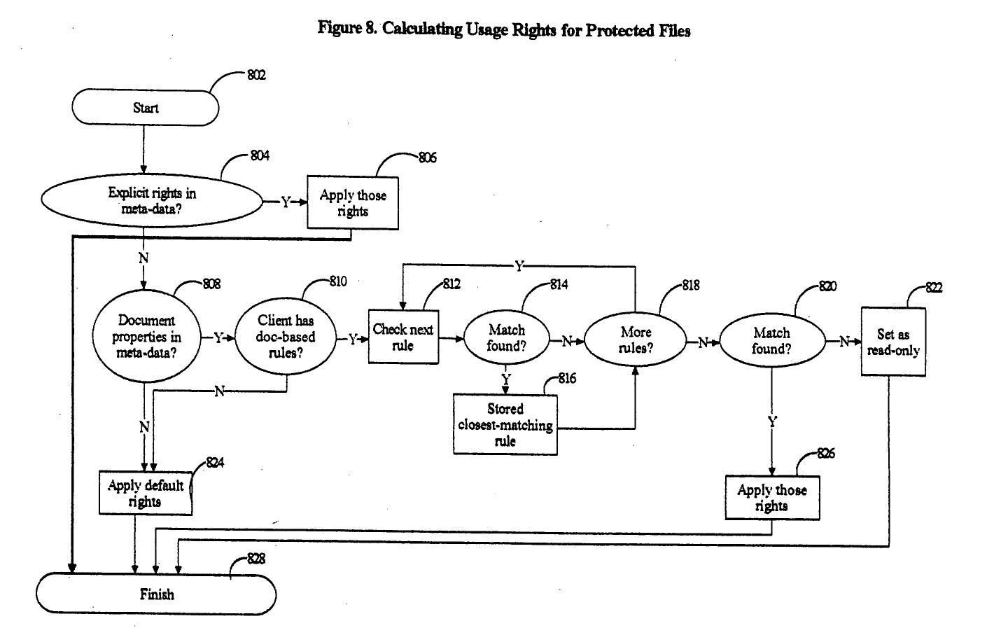

At step 722 the writer calculates the usage rights that will be applied to the process, and enters them in the record's ‘usage rights’ field (as illustrated in FIG. 8). At step 724, the writer examines those rights to determine whether they permit offline access. If they do, the writer proceeds to step 730. If they do not, at step 726 the writer determines whether the machine is offline, by consulting an ‘online’ flag that is set in the access/usage properties list when the Client starts up. In an alternative embodiment, the Server or network server is contacted at this point, in order to achieve a real-time determination of the Client's online status. If the machine is online, the writer proceeds to step 730. If it is offline, such that access is not permitted, the writer informs the process monitor—which at step 728 aborts the file-reading and displays an error dialog to the user.

At step 730, the writer examines the usage rights to determine whether forwarding of the file is permitted. If it is not, the writer at step 732 adds the machine ID of the Client computer to the meta-data, such that access to the file will be blocked on other machines. At step 734 the writer determines whether a dummy ID was inserted in the record's ‘ID’ field (step 706), which would indicate that the record does not represent a new process, but rather a file that is being embedded or loaded into an existing process. If an actual ID is in the field, it proceeds to step 740. If a dummy ID was inserted, the writer at step 736 treats the embedding/loading as a Paste operation (illustrated in FIG. 12, beginning at step 1218) in which the dummy record is treated as a protected process from which information has been copied, and the record bearing the true ID is treated as the process into which the information is being pasted. At step 738, once the usage rights based on the ‘Paste’ have been calculated, the writer deletes the dummy record.

Step 740 signifies the end of the rights-calculation procedure.

8. Calculating Usage Rights for Protected Files

Reference is now made to FIG. 8, which is a simplified flowchart of a method for calculating the usage rights that are designated for a Client computer process opening a protected file, in accordance with a preferred embodiment of the present invention. Step 802 marks the beginning of the process. At step 804 the Client's whiteboard writer searches the meta-data for an explicit usage rights designation, preferably hard-wired into the file by an extension of the core architecture, or external tool. If such a designation is found, at step 806 the writer sets those rights in the record's ‘usage rights’ field, and skips to step 828. If the meta-data does not contain an explicit rights designation, the writer at step 808 searches the meta-data for document properties, which are embedded by an extension of the core architecture when the document is first protected. If no document properties are found, the writer proceeds to step 824. If document properties are found, at step 810 the writer searches the access/usage properties list—in the properties block associated with the Server that has been specified in the meta-data—in order to determine whether the Client usage rights listed there contain document-based usage rules. If none are found, the writer proceeds to step 824. If document-based rules exist, the writer proceeds to step 812 in order to iterate through the rule list.

At step 824 the writer sets the Client's default usage rights for the specified Server as the value in the record's ‘usage rights’ field. The writer then proceeds to step 828.

At step 812 the writer examines the next rule in the list, i.e. the first rule, when the writer is beginning to iterate. At step 814 it determines whether a match was found, where a match is defined as a situation in which the values of the document properties match the required values specified for any of those properties within a given rule. For example, where the meta-data contains two property-value pairs—“DOC.GROUP=‘finance’; DOC.ROLE=‘manager’”—and the currently-examined rule is “If DOC.GROUP=‘finance’, USAGE=‘read-only’”, a match will be found, inasmuch as the rule referred to one of the two document properties (‘DOC.GROUP’), and the specified value for that property (‘finance’) was matched in the meta-data.

If the rule was matched, at step 816 the writer compares the rule with a stored ‘best match’ rule, if a match was found in a previous iteration. If there was no previous match, the current rule becomes the ‘best match’, and is stored in order to be compared with subsequent matches. Otherwise, the two rules are compared, and the rule matching the greatest number of properties is stored as the ‘best match’. If both rules match the same number of properties, the rule designating the most stringent rights is stored as the ‘best match’. At step 818, the writer determines whether there are more document-based rules to be examined. If there are more rules, the writer returns to step 812 to begin another iteration. If there are none left to be examined, the writer proceeds to step 820, in which it determines whether a ‘best match’ was found. If no match was found, at step 822 the writer sets the designation in the record's ‘usage rights’ field to ‘read-only/no forwarding’—the most stringent designation—and proceeds to step 828. If a ‘best match’ exists, the writer at step 826 sets the rights designated by that rule in the record's ‘usage rights’ field, and proceeds to step 828.

Step 828 signifies the end of the rights-calculation method.

9. Monitoring for Conditionally-Protected Processes

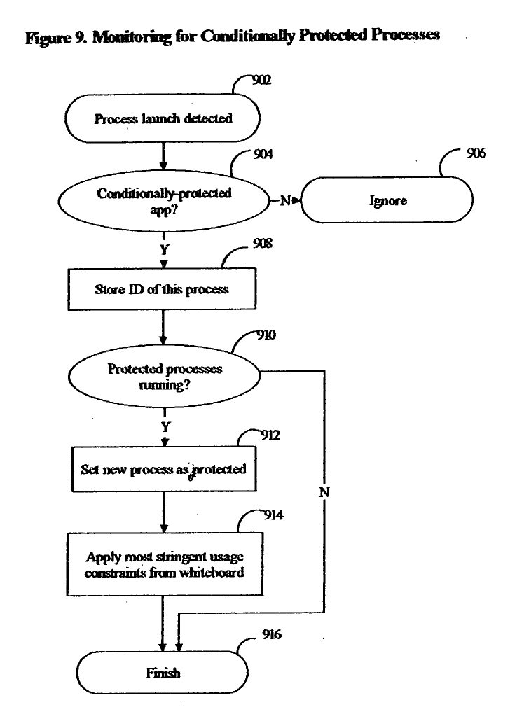

Reference is now made to FIG. 9, which is a simplified flowchart of a method for monitoring for the launch of conditionally-protected processes, in accordance with a preferred embodiment of the present invention. At step 902, the Client' process monitor detects the launch of a new process on the Client machine. At step 904 the process monitor scans the application code that is loaded into memory in order to determine whether that application appears in the conditionally-protected applications list. If the application does not appear, the process monitor at step 906 takes no action. If the application does appear in the list, at step 908 the process monitor stores the ID and, preferably, the window handle of the newly-launched process. At step 910 the process monitor consults the protected processes whiteboard in order to determine whether any protected processes are currently running. If there are currently no protected processes, the process monitor proceeds to step 916. If protected processes are currently running, at step 912 the process monitor passes the ID information and a ‘conditionally-protected’ flag to the whiteboard writer, which adds a new record to the whiteboard to represent the new process. At step 914, the writer finds the most stringent usage rights listed for current whiteboard records, and sets those rights in the ‘usage rights’ field of the new record. Step 916 signifies the end of the method.

10. Placing Protected Data on the Clipboard via Cut/Copy/<ALT>Print Screen

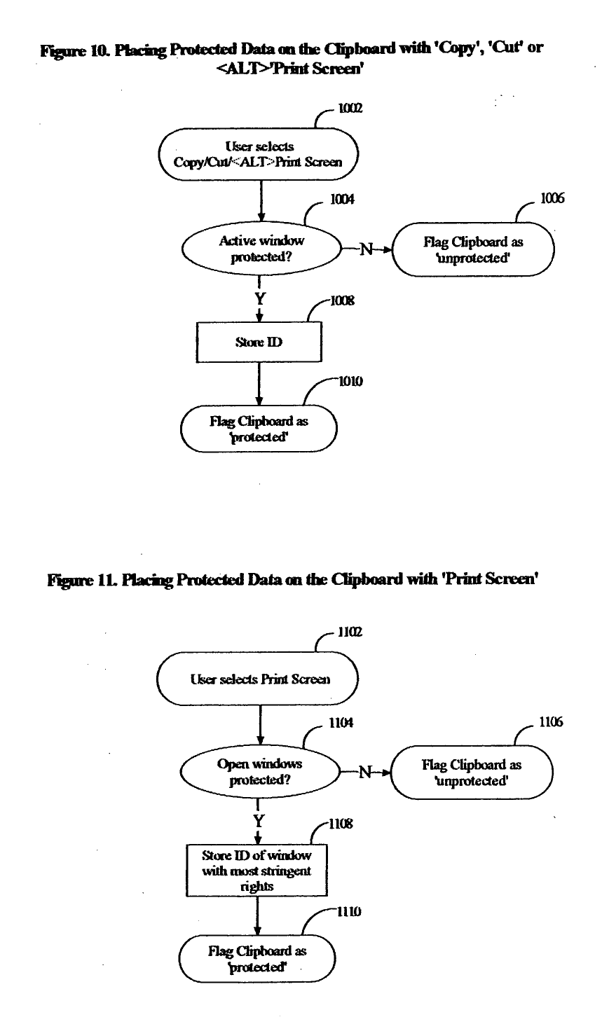

Reference is now made to FIG. 10, which is a simplified flowchart of a method for monitoring protected data that is transferred to the Windows clipboard via ‘Cut’ or ‘Copy’ operations, or via an <ALT>‘Print Screen’ keystroke combination, in accordance with a preferred embodiment of the present invention. At step 1002, the Client's process monitor intercepts a call to modify the contents of the Windows clipboard, e.g. ‘SetClipboardData’, via ‘Cut’ or ‘Copy’ or an <ALT>Print Screen keystroke combination. At step 1004 it obtains the handle of the active window, which is the source of the call if Cut/Copy was selected, or the target of the call if <ALT>Print Screen was selected. The process monitor then consults the whiteboard in order to determine whether the window is protected, i.e., whether a record bearing that handle as part of its ID appears in the list. If it is not protected, at step 1006 the process monitor sets an internal ‘clipboard’ flag to ‘unprotected’. If it is protected, at step 1008 the process monitor stores the ID of the corresponding record, and at step 1010 it sets its ‘clipboard’ flag to ‘protected’.

11. Placing Protected Data on the Clipboard via Print Screen

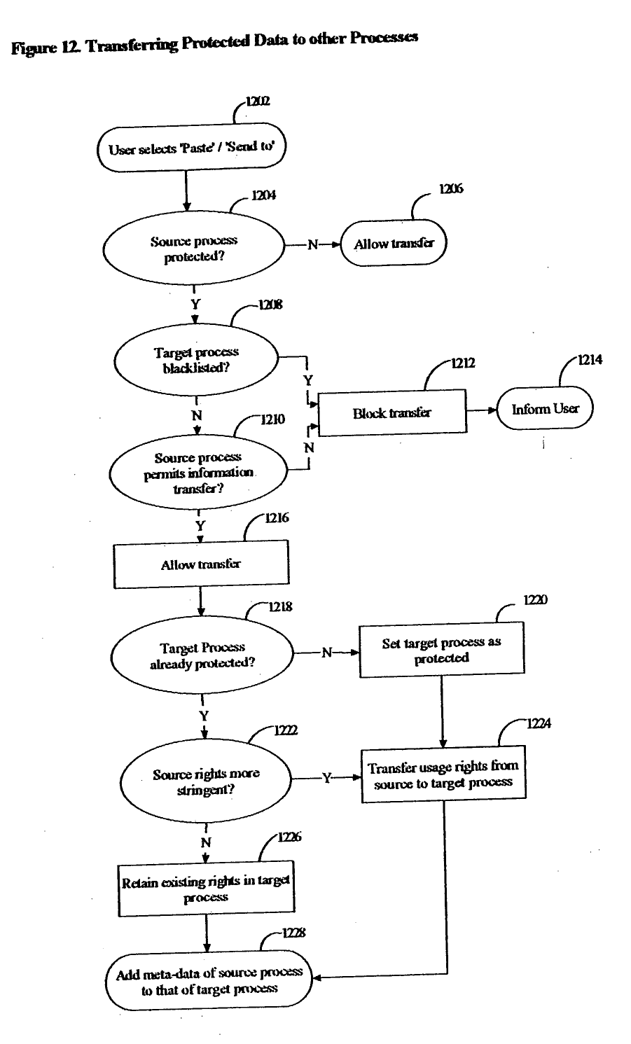

Reference is now made to FIG. 11, which is a simplified flowchart of a method for monitoring protected data that is transferred to the Windows clipboard via the ‘Print Screen’ key, in accordance with a preferred embodiment of the present invention. At step 1102, the Client's process monitor intercepts a call to modify the contents of the Windows clipboard, e.g. ‘SetClipboardData’, in conjunction with a ‘Print Screen’ keystroke. At step 1104 it obtains the handles of currently-open windows, which are the ones to appear in the ‘Print Screen’ snapshot, and then consults the whiteboard in order to determine whether any of those windows are protected; i.e., whether there are any records bearing those handles as part of their ID. If none of the windows protected, at step 1106 the process monitor sets an internal ‘clipboard’ flag to ‘unprotected’. If there are protected windows, at step 1108 the process monitor stores the ID of the corresponding record from among those windows that contains the most stringent usage rights, and at step 1110 it sets its ‘clipboard’ flag to ‘protected’.

12. Transferring Protected Data to other Processes

Reference is now made to FIG. 12, which is a simplified flowchart of a method for transferring protected data to another process on the Client computer while preserving the data's attributes, in accordance with a preferred embodiment of the present invention. At step 1202, the process monitor intercepts a user's attempt to transfer data. If the transfer mechanism is pasting of clipboard data into another process, the process monitor intercepts the underlying function call, e.g. ‘GetClipboardData’. If the transfer mechanism is programmatic forwarding of process data to another process, i.e., a ‘Send to . . . ’ option selected by the user, the process monitor captures the associated Windows ‘WM_COPYDATA’ message that is broadcast by the forwarding process or, alternatively, it intercepts COM forwarding functions that are called when pipes to other processes are established.

At step 1204 the process monitor determines whether the source process, i.e., the process from which the data originated, is protected. Where the transfer mechanism is pasting from the clipboard, the process monitor determines this by checking the value of its internal ‘clipboard status’ flag and the stored process ID, which are set when the user modifies the clipboard contents, as illustrated in FIGS. 9 and 10. Where the information is being transferred via programmatic forwarding, the process monitor consults the protected processes whiteboard to determine whether the process that broadcast the ‘WM_COPYDATA’ message or, alternatively, the process that called the COM forwarding functions, is protected. If the source process is not protected, at step 1206 the process monitor allows the transfer to proceed normally.

If the source process is protected, at step 1208 the process monitor determines whether the target process, i.e., the process that is to receive the data, is blacklisted; that is, whether it has been launched by an application that appears in the Client's ‘Blacklisted Applications’ list. If the process is blacklisted, the process monitor proceeds to step 1212. If it is not blacklisted, at step 1210 the process monitor consults the whiteboard to determine whether the usage rights designated for the source process permit transfer of information to other processes. If the rights permit data transfer, the process monitor proceeds to step 1216. If they do not permit data transfer, the process monitor proceeds to step 1212. At step 1212 the process monitor blocks the data-transferring function, e.g. ‘GetClipboardData’ for paste, or COM or other data transfer functions for programmatic forwarding, and at step 1214 the user is informed via an error dialog that the operation was aborted.

At step 1216, once data transfer issues for both the source and the target process have been resolved, the process monitor allows the data transfer to proceed. It then sends the ID's of the source and target process to the whiteboard writer. At step 1218 the writer consults the whiteboard to determine whether the target process is already protected. If it is not, at step 1220 the writer creates a new record for the target process, where the target process ID is supplied by the process monitor, while all other values are copied from the source process record; among these values are usage rights, at step 1224. The writer then proceeds to step 1228.

If the target process is already protected, at step 1222 the writer consults the whiteboard to determine whether the usage rights in the source process are more stringent than those of the target process. If the source rights are more stringent, the writer at step 1224 sets those rights in the ‘usage rights’ field of the target record, and proceeds to step 1228. If the source rights are no more stringent than those of the target process, the writer at step 1226 retains the existing rights that are designated in the target record, and proceeds to step 1228.

At step 1228, the writer rewrites the meta-data string of the target record to include the values of the source record's string, using the following rules: if the meta-data string in either record contains embedded rights information, the most stringent version is preserved; if the meta-data in either record contains document properties, these are combined—such that a given document property could conceivably acquire multiple values, which serve as alternatives in the rule-matching process.

13. Printing Protected Data

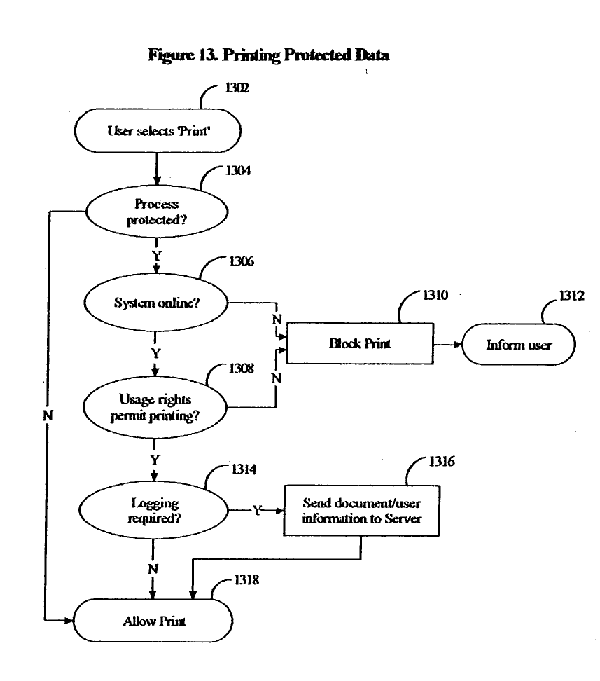

Reference is now made to FIG. 13, which is a simplified flowchart of a method for printing protected information, in accordance with a preferred embodiment of the present invention. At step 1302, a user launches a Print operation, and the Client's process monitor intercepts the resultant call to ‘TextOut’, or a similar function, to output information to a printing device. At step 1304 the process monitor consults the protected processes whiteboard in order to determine whether the process which made the call is protected. If it is not protected, the process monitor skips to step 1318. If the process is protected, at step 1306 the process monitor determines whether the Client computer is currently online by consulting an ‘online’ flag in the access/usage properties list or, alternatively, by ‘pinging’ the Server or a network server. If the computer is currently offline, the process monitor proceeds to step 1310. If it is online, at step 1308 the process monitor consults the whiteboard to determine whether the usage rights designated for this process allow printing. If printing is not allowed, at step 1310 the process monitor aborts the print operation, and at step 1312 displays an error dialog to the user.

If printing is allowed, at step 1314 the process monitor determines whether the rights designated for this process require that the print job be logged. If logging is required, at step 1316 the process monitor sends relevant document information, e.g. a ‘Document ID’ property embedded in a protected document's meta-data by an extension of the core architecture, to the Client's I/O manager. The I/O manager then posts a ‘Print’ message to the Server, sending the document information along with a unique identifier of the user, e.g. login ID or email address.

At step 1318, the process monitor allows the Print operation to proceed.

14. Saving Protected Data

Reference is now made to FIG. 14, which is a simplified flowchart of a method for saving protected information to disk, in accordance with a preferred embodiment of the present invention. At step 1402, the user selects ‘Save’ for process/window information, or Windows attempts to automatically save the information to a temporary file on disk. The Client's process monitor then intercepts the underlying Windows function call, e.g. ‘WriteFile’ where the file is being saved to the local computer, or ‘WriteStream’ where the file is being saved to a remote computer. At step 1404 the process monitor consults the protected processes whiteboard in order to determine whether the process which made the call is protected. If it is not, the process monitor skips to step 1418. If the process is protected, at step 1406 the process monitor consults the whiteboard to determine whether the usage rights designated for this process allow saving of information to disk. If saving is not allowed—e.g., the process is designated as ‘read-only’—at step 1408 the process monitor aborts the save operation, and at step 1410 displays an error dialog to the user.

If saving is allowed, at step 1412 the process monitor invokes the Client's encrypter, which accesses the whiteboard record corresponding to the process in question. The encrypter then compiles a meta-data string by concatenating the information in the record's ‘Server’, ‘encrypting DEK’, and ‘meta-data’ fields, and inserts ‘start’ and ‘end’ flags at the beginning and at the end of the string. At step 1414 the encrypter inserts the meta-data string at the head of the target information. At step 1416 the encrypter retrieves the DEK specified in the ‘encrypting DEK’ field from the DEK list associated with the specified Server in the Client's access/usage properties list. The encrypter then encrypts the meta-data appearing after the ‘start’ flag, Server ID and DEK ID values, and the file information itself.

At step 1418, the process monitor passes the information to the calling function, allowing it to be saved to disk.

15. Monitoring for Shutdown of Protected Processes or Windows

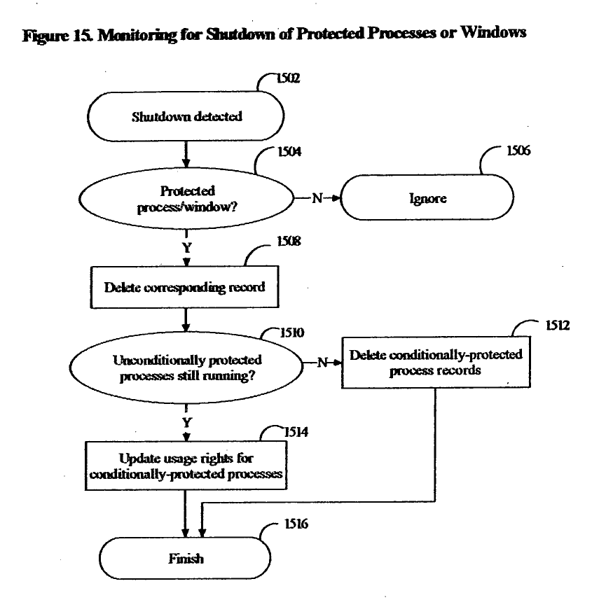

Reference is now made to FIG. 15, which is a simplified flowchart of a method for monitoring the shutdown of protected processes or windows, in accordance with a preferred embodiment of the present invention. At step 1502 the Client's process monitor detects the shutdown of a process/window on the Client machine. At step 1504 the process monitor consults the whiteboard in order to determine whether the process/window that has shut down was protected. If it was not, at step 1506 the process monitor takes no further action. If it was protected, at step 1508 the process monitor sends the process/window ID to the whiteboard writer, along with an instruction ‘Delete’; the writer then deletes the record.

At step 1510 the writer consults the whiteboard in order to determine whether there are any records not flagged as ‘conditionally-protected’, i.e., whether any unconditionally protected processes are still running. If there are not, at step 1512 the writer deletes all remaining records, which represent conditionally-protected processes that no longer need to be protected; the writer then proceeds to step 1516. If there are still unconditionally protected processes running, at step 1514 the writer updates the usage rights for any conditionally-protected processes, so as to ensure that they possess the most stringent rights currently appearing in the whiteboard.

Step 1516 signifies the end of the method.

16. GUI: ‘Keys’ Tab

Reference is now made to FIG. 16, which is an illustration of a user interface tab for managing the Server's authentication key and de/encryption key lists, in accordance with a preferred embodiment of the present invention. The tab contains two list boxes—one for each key type—whose entries are the ID's of the keys currently stored in each respective list. Below the authentication key list are ‘New’ and ‘Delete’ buttons, and next to it are labels indicating the directories on the Server machine in which the Client and Server keys comprising the public-private pair are stored.

Clicking on the ‘New’ button brings up a dialog which prompts the user to enter an ID for the new key. Once the user does so, the key pair is generated by the Server, where the user-entered ID is used for the name of each key in the pair. The newly-generated Client and Server components are placed in the respective directories that are indicated by the aforementioned labels; the Client key can be subsequently retrieved from its directory, and added to a Client installation package. The tab is then refreshed, and the new ID subsequently appears in the list box. Clicking on the ‘Delete’ button brings up a warning dialog; if the user continues, the Server key corresponding to the selected ID in the list is deleted. The tab is then refreshed, and the deleted ID no longer appears.

Below the de/encryption key (DEK) list box are ‘New’ and ‘Delete’ buttons. Next to the list box are two labels and a button: the first label indicates the directory on the Server machine in which the DEK's are stored; the second label displays the ID of the current default DEK—or the string ‘NONE’ if no DEK has been selected. Below the labels is a ‘Set Selected Key as Default DEK’ button.

Clicking on the ‘New’ button brings up a dialog which prompts the user to enter an ID for the new key. Once the user does so, the Server generates the key, utilizing the user-entered ID for the name; the newly-generated key is then placed in the directory indicated by the aforementioned label. The tab is then refreshed, and the new ID subsequently appears in the list box. Clicking on the ‘Delete’ button brings up a warning dialog. If the user continues, the DEK corresponding to the selected ID in the list is deleted. The tab is then refreshed, and the deleted ID no longer appears. Clicking on the ‘Set Selected Key as Default DEK’ button sets the DEK that is currently selected in the list as the default DEK. The tab is then refreshed, and the ‘Default DEK’ label now displays the ID that had been selected.

17. GUI: ‘Usage Rules’ Tab

Reference is now made to FIG. 17, which is an illustration of a user interface tab for managing the Server's usage rule list, in accordance with a preferred embodiment of the present invention. The tab is comprised of a list of existing rules and a rule-building engine, manifested within a Java applet, or alternatively, via JavaScript. The rule-building engine enables the administrator to formulate a given rule's conditions and designate the resultant usage rights, such that new rules can be generated and existing ones modified.

The administrator formulates a rule's condition/s—i.e. the criteria for establishing a match—by selecting any combination of user and/or document properties, sent as applet parameters, and defining required values for them, e.g., “If ROLE=‘manager’” and “If DOC.GROUP=‘development’”. Complex conditions can be developed by stringing together any number of property-value pairs using Boolean logic, e.g., “If ROLE=‘manager’ and GROUP=‘marketing’”. The engine also allows for partial matches, e.g. “If GROUP starts with ‘R&D’”; this provides room for eventual emergence of subgroups e.g., ‘R&D/QA’, that may share some rules with the parent group, but be capable of possessing differentiated rights as well. In addition, the engine provides a mechanism for nesting conditionality under defined ‘cases’, equivalent to ‘nested IF’. The ‘case’ is itself a single property-value condition; e.g. “CASE: ROLE=‘employee’: if GROUP=‘finance’, . . . ; else if GROUP=‘development’, . . . ”. This nesting functionality enables the administrator to create rule ‘categories’, and thus better organize and simplify the rule set. Once the conditions are defined, the administrator can select the appropriate outcome in terms of permitted usage, listed in descending stringency: ‘read-only; no forwarding’ vs. ‘read-only’ vs. ‘editable: no transfer’ vs. ‘editable: no printing’ vs. ‘editable: log print jobs’ vs. ‘normal’, as well as whether information can be accessed offline.

The tab's GUI is comprised of two primary areas: a list box, with associated ‘Edit’ and ‘Delete’ buttons, that displays the usage rules that are currently stored on the Server and which are received as applet parameters; and the rule-building GUI. Clicking on the list's ‘Edit’ button loads the currently-selected entry into the rule-building engine's status-display box, as described below, and changes the box's label from ‘Create Rule’ to ‘Edit Rule’. Clicking on the ‘Delete’ button causes the currently-selected rule to be deleted from the Server's list; the page is then refreshed—and the deleted rule is no longer displayed in the list.

The rule-building GUI is comprised of a status-display box for the target rule, a condition-building area, a rights-designation area, and a set of rule-processing buttons. The status-display box shows the current state of the target rule. To clarify the specified conditionality and outcome/s, the rule is parsed so that conditions and outcomes each appear on new lines, while sub-conditions and outcomes are indented under their parent condition. The status-display box is editable; thus, the administrator can delete lines, insert new lines of added conditionality, and manually edit text. When the administrator clicks on buttons that designate conditions or outcomes, as described below, the status-display box is refreshed automatically to include the changes. The rule is also reparsed at this time to appropriately show indentation.

The condition-building area is comprised of the following controls: ‘condition type’ radio button options; a drop-down list of property names; ‘comparison criterion’ radio button options; an associated ‘DOES NOT’ checkbox; a ‘property value’ text field; a ‘Continue Condition’ button; and ‘AND/OR’ radio button options. To define the basic building blocks of a condition, the administrator selects a property name from the drop-down list, and enters a required value in the ‘property value’ text field. S/he then selects a comparison criterion from the appropriate radio button options: ‘equals’ vs. ‘starts with’ vs. ‘ends with’; the criterion can be designated as a logical NOT by selecting the ‘DOES NOT’ checkbox, e.g., creating criteria such as ‘DOES NOT equal’. In this manner, simple statements are created, e.g., ‘ROLE=‘manager’. A statement is designated as a condition by selecting the appropriate option from the ‘condition type’ radio button group: a given statement can be designated as a ‘case’—i.e., a logical ‘if’ under which additional ‘if’ statements can be nested; as part of an ‘if’ condition; or as part of an ‘else (if)’ condition.

Simple conditions can be expanded by clicking the ‘Continue Condition’ button, which is activated if the administrator has selected ‘if’ or ‘else (if)’ as the condition type, and has designated both a property name and required value. When this button is clicked, the condition statement currently designated in the condition-building controls, e.g. “If ROLE=‘manager’”, is added to the status-display box. If the ‘Continue Condition’ button has been newly-activated, indicating that the current iteration is the beginning of a new condition, the statement overwrites the line in the status-display box at which the caret is currently positioned; otherwise, the statement is appended to the line at which the caret is positioned. In addition, when the button is clicked, the ‘AND/OR’ radio buttons are activated, and the property drop-down list and text field are set to their default settings. Thus, another statement-building iteration can commence.

The administrator specifies the designated rights for a given condition by selecting one of the entries in the ‘usage rights’ drop-down list. Offline access is designated by selecting the ‘Allow offline access’ checkbox.

There are three rule-processing buttons: ‘Continue Rule Construction’, Submit Rule’, and ‘Cancel’. When ‘Continue Rule Construction’ is clicked, the following actions are performed: if the administrator has defined a condition statement in the current statement-building iteration—such that the property-name and property-value controls are not at their default settings—the statement is appended to the line in which the caret is currently located in the status-display box, and the caret is then set to the following line; the designated rights for this condition are entered in the status-display box, overwriting the line in which the caret is now located; if the currently-selected ‘condition type’ radio option has been ‘IF’, the ‘ELSE/IF’ option is now selected by default; and lastly, the ‘Continue Condition’ button and ‘AND/OR’ radio options are deactivated, indicating that a new condition may now be defined. When ‘Submit Rule’ is clicked, the rule text in the status-display box undergoes a syntactic check: if there is a rule syntax error, a dialog appears to notify the user; otherwise, the rule is submitted to the Server, and the ‘Usage Rules’ tab is refreshed—such that the new rule now appears in the usage rules list box. When ‘Cancel’ is clicked, the status-display box is cleared, and all GUI controls are set to their default settings.

18. GUI: ‘User Profiles’ Tab

Reference is now made to FIG. 18, which is an illustration of a user interface tab for determining the mechanism that is used to generate user profiles, in accordance with a preferred embodiment of the present invention. The tab displays three radio button options for generating the profiles. If the first option is selected, given user profiles are to be generated by querying a user directory. The accompanying text field ‘Query Address’ is activated, and the administrator enters the required query text in the appropriate directory protocol, e.g., LDAP; the Client-supplied parameter—unique ID—is added at run time.

If the second option is selected, user profiles are to be generated by querying a database. The accompanying text field ‘Location’ is activated, and the administrator enters the location of the database, which will be queried by the profile generator using SQL; the Client-supplied parameter—unique ID—is added at run time.

If the third option is selected, the profile generator when queried will simply return a dummy value “ID=user”. In this manner, a common, default profile is created for all users; such a profile may be utilized if all users will be granted the same usage rights.

A ‘Submit’ button appearing beneath the options is clicked by the administrator to indicate that s/he has completed selection and/or text entry.

19. GUI: ‘Predesignated Applications’ Tab

Reference is now made to FIG. 19, which is an illustration of a user interface tab for managing lists of applications that have been designated for special handling, in accordance with a preferred embodiment of the present invention. The tab contains two sets of labels: one set, indicating the Server directory that houses the ‘blacklisted applications’ list, as well as the date, based on the request handler timestamp, that the list was last updated; and the other set bearing similar information for the ‘conditionally-protected applications’ list. Below each set of labels is a button titled ‘Load New List’. If a given button is clicked, the contents of the respective file are loaded from the indicated directory into the Server's memory, replacing the current list. The tab is then refreshed, where the ‘last-updated’ label for the selected list now bears the current date.

20. GUI: ‘Special Directives’ Tab

Reference is now made to FIG. 20, which is an illustration of a user interface tab for issuing specific directives to individual clients, in accordance with a preferred embodiment of the present invention. The tab is comprised of an area for managing existing directives, and an area for generating new ones. The ‘Current Directives’ area contains a list box, displaying the directives that are currently stored in the table of the Server's request handler, and an associated ‘Delete’ button. When the ‘Delete’ button is clicked, the directive that is currently selected in the list box is deleted from the request handler's table. The tab is subsequently refreshed, and the deleted directive no longer appears.

The ‘New Directive’ area contains a text field for entering a Client ID, a drop-down list displaying the available directives, and a ‘Submit’ button. When the ‘Submit’ button is clicked, a new directive is posted to the request handler's table, comprised of the Client ID that has been entered in the text field and the directive that is currently selected in the drop-down list. The tab is then refreshed, and the new directive now appears in the ‘Current Directives’ list box.

In reading the above description, persons skilled in the art will realize that there are many apparent variations that can be applied to the methods and systems described.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. A computer data security system, comprising
a file parser for determining if a computer file contains protected data;
a file decrypter for decrypting encoded files;
a file encrypter for re-encoding decrypted files that have been modified;
a rights processor for determining data usage rights for a process that has been launched, the data usage rights restricting the process by limiting permissible data access commands that can be issued by the process; and
a process monitor for monitoring processes within a computer, comprising:
a command interceptor for intercepting a data access command issued by the process; and
a command blocker for blocking the intercepted command if the intercepted command accesses protected data, and if the data usage rights indicate that the command is not permissible.

2. The computer data security system of claim 1 wherein the data usage rights are derived from meta-data stored within a file containing protected data.

3. The computer data security system of claim 1 wherein the data usage rights are derived from user privileges.

4. The computer data security system of claim 1 wherein certain processes are tagged as conditionally protected, a conditionally protected process being restricted by data usage rights only when a restricted process is also running.

5. The computer data security system of claim 4 wherein the conditionally protected processes are processes that can copy data from memory to memory.

6. The computer data security system of claim 1 wherein certain processes are tagged as being blacklisted, a blacklisted processes preventing launch of a restricted process while the blacklisted process is running.

7. The computer data security system of claim 1 wherein the intercepted data access command is an open file command.

8. The computer data security system of claim 1 wherein the intercepted data access command is a save file command.

9. The computer data security system of claim 1 wherein the intercepted data access command is an edit command.

10. The computer data security system of claim 1 wherein the intercepted data access command is a print command.

11. A method for computer data security, comprising
determining if a computer file contains protected data;
decrypting encoded files;
re-encoding decrypted files that have been modified;
determining data usage rights for a process that has been launched, the data usage rights restricting the process by limiting permissible data access commands that can be issued by the process;
intercepting a data access command issued by the process; and
blocking the intercepted command if the intercepted command accesses protected data, and if the data usage rights indicate that the command is not permissible.

12. The method of claim 11 wherein the data usage rights are derived from meta-data stored within a file containing protected data.

13. The method of claim 11 wherein the data usage rights are derived from user privileges.

14. The method of claim 11 wherein certain processes are tagged as conditionally protected, a conditionally protected process being restricted by data usage rights only when a restricted process is also running.

15. The method of claim 14 wherein the conditionally protected processes are processes that can copy data from memory to memory.

16. The method of claim 11 wherein certain processes are tagged as being blacklisted, a blacklisted processes preventing launch of a restricted process while the blacklisted process is running.

17. A computer data security system, comprising:
a file parser for determining if a computer file contains protected data;
a file decrypter for decrypting encoded files into memory;
a file encrypter for encrypting files containing protected data; and
a security processor for indicating to a process that data it receives from memory is protected data.

18. The computer data security system of claim 17 further comprising a rights processor for determining data usage rights for a process that has been launched, the data usage rights restricting the process by limiting permissible data access commands that can be issued by the process.

19. The computer data security system of claim 17 further comprising a rights processor for determining data usage rights for a process that receives protected data from memory, the data usage rights restricting the process by limiting permissible data access commands that can be issued by the process.

20. The computer data security system of claim 17 wherein said file encrypter encrypts a file generated by a process from protected data the process received from memory.
